(19) United States
(12) Patent Application Publication
(10) Pub. No.: US 2025/0343928 A1
(43) Pub. Date: Nov. 6, 2025

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Zhipin DENG, Beijing (CN); Kai Zhang, Los Angeles, CA (US); Li Zhang, Los Angeles, CA (US)

(21) Appl. No.: 19/267,437

(22) Filed: Jul. 11, 2025

Related U.S. Application Data
(63) Continuation of application No. PCT/CN2024/071888, filed on Jan. 11, 2024.

(30) Foreign Application Priority Data
Jan. 13, 2023 (WO) PCT/CN2023/072029

(51) Int. Cl. H04N 19/189; H04N 19/105; H04N 19/132; H04N 19/176; H04N 19/186; H04N 19/50

(52) U.S. Cl. CPC H04N 19/189; H04N 19/105; H04N 19/132; H04N 19/176; H04N 19/186; H04N 19/50

(57) ABSTRACT

Embodiments of the present disclosure provide a solution for video processing. A method for video processing is proposed. In the method, for a conversion between a current video block of a video and a bitstream of the video, a coding tool for the current video block is determined based on a regression model. The conversion is performed based on the coding tool. The regression model is associated with at least one of: a division-free operation, or a coefficient determination operation.

### CROSS REFERENCE TO RELATED APPLICATIONS

This application is a continuation of International Application No. PCT/CN2024/071888, filed on Jan. 11, 2024, which claims the benefit of International Application No. PCT/CN2023/072029 filed on Jan. 13, 2023. The entire contents of these applications are hereby incorporated by reference in their entireties.

### FIELDS

Embodiments of the present disclosure relates generally to video processing techniques, and more particularly, to regression model and offset removal for video coding.

### BACKGROUND

In nowadays, digital video capabilities are being applied in various aspects of peoples' lives.

Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a current video block of a video and a bitstream of the video, a coding tool for the current video block based on a regression model; and performing the conversion based on the coding tool, wherein the regression model is associated with at least one of: a division-free operation, or a coefficient determination operation. The method in accordance with the first aspect of the present disclosure determines a coding tool based on a regression model and uses the coding tool for the conversion. The coding efficiency and coding effectiveness can thus be improved.

In a second aspect, another method for video processing is proposed. The method comprises: determining, for a conversion between a current video block of a video and a bitstream of the video, a coding tool of the current video block based on an offset removal operation; and performing the conversion based on the coding tool. The method in accordance with the second aspect of the present disclosure determines a coding tool based on an offset removal operation and uses the coding tool for the conversion. The coding efficiency and coding effectiveness can thus be improved.

In a third aspect, an apparatus for video processing is proposed. The apparatus comprises a processor and a non-transitory memory with instructions thereon. The instructions upon execution by the processor, cause the processor to perform a method in accordance with the first aspect or the second aspect of the present disclosure.

In a fourth aspect, a non-transitory computer-readable storage medium is proposed. The non-transitory computer-readable storage medium stores instructions that cause a processor to perform a method in accordance with the first aspect or the second aspect of the present disclosure.

In a fifth aspect, another non-transitory computer-readable recording medium is proposed. The non-transitory computer-readable recording medium stores a bitstream of a video which is generated by a method performed by an apparatus for video processing. The method comprises: determining a coding tool for a current video block of the video based on a regression model; and generating the bitstream based on the coding tool, wherein the regression model is associated with at least one of: a division-free operation, or a coefficient determination operation.

In a sixth aspect, a method for storing a bitstream of a video is proposed. The method comprises: determining a coding tool for a current video block of the video based on a regression model; generating the bitstream based on the coding tool; and storing the bitstream in a non-transitory computer-readable recording medium, wherein the regression model is associated with at least one of: a division-free operation, or a coefficient determination operation.

In a seventh aspect, another non-transitory computer-readable recording medium is proposed. The non-transitory computer-readable recording medium stores a bitstream of a video which is generated by a method performed by an apparatus for video processing. The method comprises: determining a coding tool for a current video block of the video based on an offset removal operation; and generating the bitstream based on the coding tool.

In an eighth aspect, a method for storing a bitstream of a video is proposed. The method comprises: determining a coding tool for a current video block of the video based on an offset removal operation; generating the bitstream based on the coding tool; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4A and FIG. 4B illustrate the effect of the slope adjustment parameter “u”, where FIG. 4A corresponds to a model created with the current CCLM, and FIG. 4B corresponds to a model updated as proposed;

FIG. 5 illustrates neighbouring blocks (L, A, BL, AR, AL) used in the derivation of a general MPM list;

FIG. 6 illustrates neighboring reconstructed samples used for DIMD chroma mode;

FIG. 7 illustrates an intra template matching search area used;

FIG. 8A and FIG. 8B illustrate a division method for angular modes, respectively;

FIG. 9 illustrates an extended MRL candidate list;

FIG. 10 illustrates a spatial part of the convolutional filter;

FIG. 11 illustrates a reference area (with its paddings) used to derive the filter coefficients;

FIG. 12 illustrates four Sobel based gradient patterns for GLM;

FIG. 13 illustrates a template area;

FIG. 14 illustrates a flowchart of a method for video processing in accordance with embodiments of the present disclosure;

FIG. 15 illustrates a flowchart of a method for video processing in accordance with embodiments of the present disclosure; and

FIG. 16 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

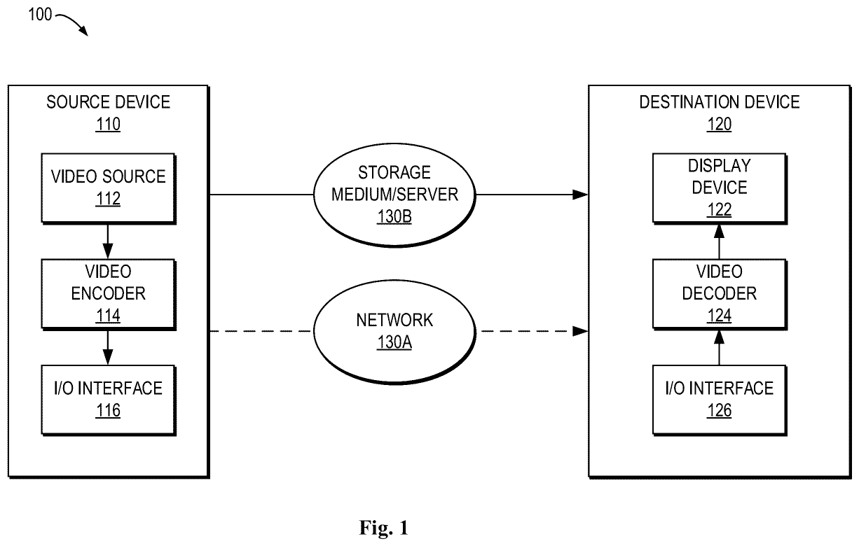

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

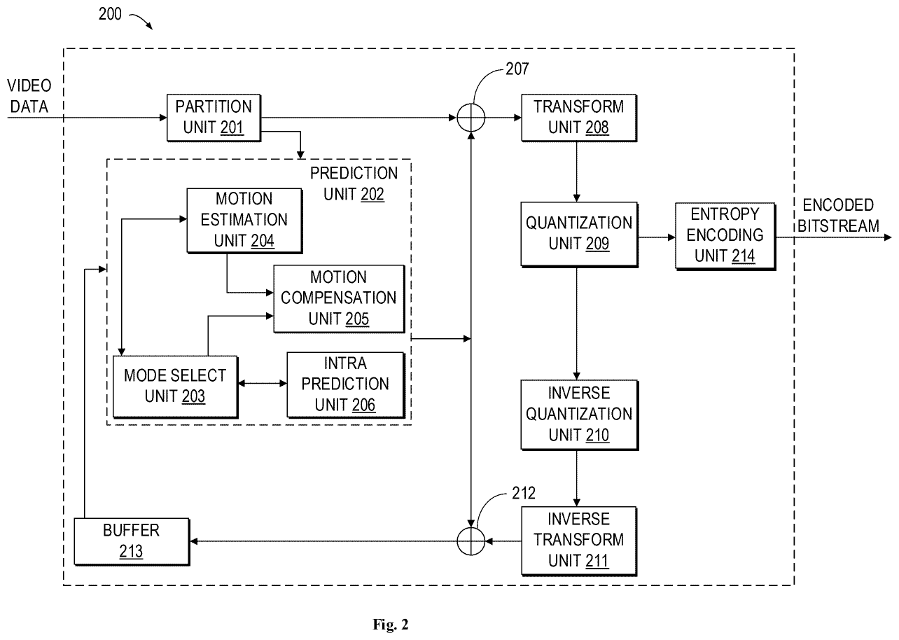

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components.

The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

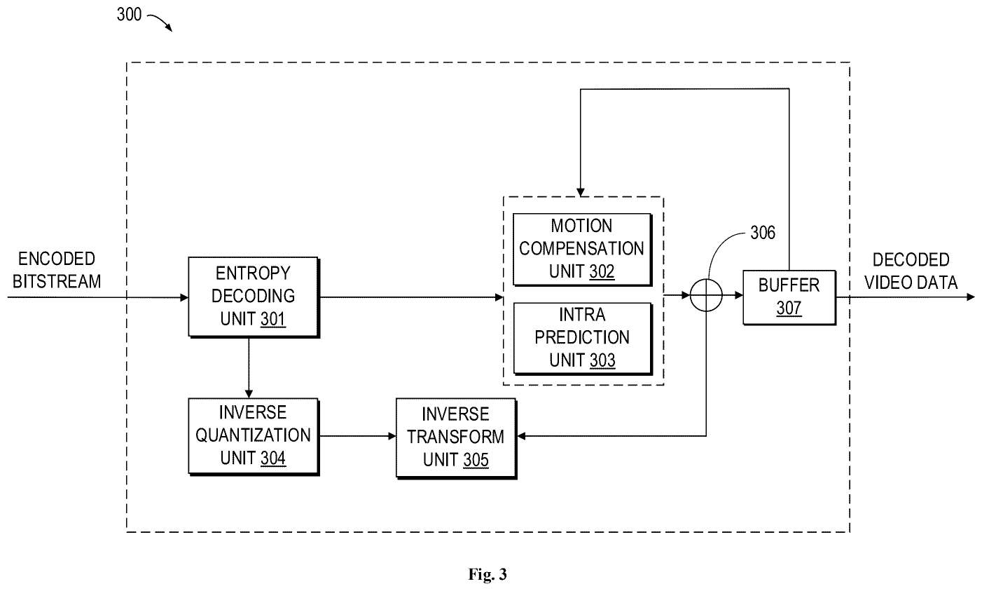

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This disclosure is related to video coding technologies. Specifically, it is about linear/non-linear/polynomial regression model prediction, and offset removal related algorithms in image/video coding. It may be applied to the existing video coding standard like HEVC, VVC, and etc. It may be also applicable to future video coding standards or video codec.

### 2. Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 JVET meeting, and the first version of VVC test model (VTM) was released at that time. The VVC working draft and test model VTM are then updated after every meeting. The VVC project achieved technical completion (FDIS) at the July 2020 meeting.

### 2.1 Intra Prediction

In intra prediction the smallest chroma intra prediction unit (SCIPU) constraint in VVC is removed. In addition, the VPDU constraint for reducing CCLM prediction latency is also removed.

### 2.1.1 Multi-model LM (MMLM)

CCLM included in VVC is extended by adding three Multi-model LM (MMLM) modes. In each MMLM mode, the reconstructed neighboring samples are classified into two classes using a threshold which is the average of the luma reconstructed neighboring samples. The linear/non-linear/polynomial regression model of each class is derived using the Least-Mean-Square (LMS) method. For the CCLM mode, the LMS method is also used to derive the linear/non-linear/polynomial regression model. A slope adjustment to is applied to cross-component linear/non-linear/polynomial regression model (CCLM) and to Multi-model LM prediction. The adjustment is tilting the linear function which maps luma values to chroma values with respect to a center point determined by the average luma value of the reference samples.

### 2.1.1.1 Slope Adjustment of CCLM

CCLM uses a model with 2 parameters to map luma values to chroma values. The slope parameter “a” and the bias parameter “b” define the mapping as follows:

$$chroma Val = a * lumaVal + b .$$

An adjustment “u” to the slope parameter is signaled to update the model to the following form:

$$chroma Val = a ’ * lumaVal + b ’$$

$$where$$

$$\begin{matrix}a ’ = a + u , \\ b ’ = b - u * {y}_{r} .\end{matrix}$$

With this selection the mapping function is tilted or rotated around the point with luminance value yr. The average of the reference luma samples used in the model creation as yr in order to provide a meaningful modification to the model. Picture below illustrates the process.

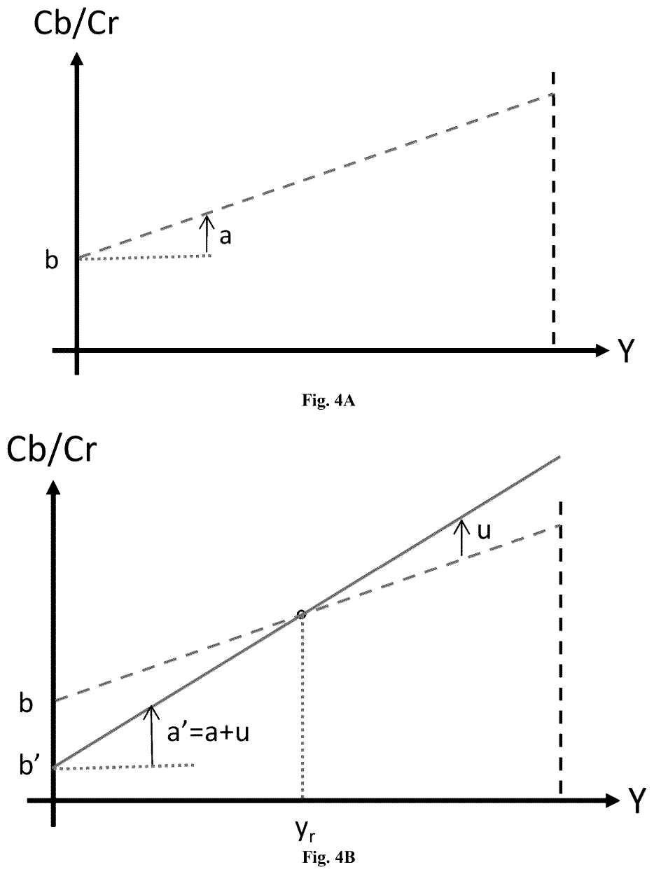

FIG. 4A and FIG. 4B illustrate the effect of the slope adjustment parameter “u”, where FIG. 4A corresponds to a model created with the current CCLM, and FIG. 4B corresponds to a model updated as proposed.

### Implementation

Slope adjustment parameter is provided as an integer between −4 and 4, inclusive, and signaled in the bitstream.

The unit of the slope adjustment parameter is ⅛^{th} of a chroma sample value per one luma sample value (for 10-bit content).

Adjustment is available for the CCLM models that are using reference samples both above and left of the block (“LM_CHROMA_IDX” and “MMLM_CHROMA_IDX”), but not for the “single side” modes. This selection is based on coding efficiency vs. complexity trade-off considerations.

When slope adjustment is applied for a multimode CCLM model, both models can be adjusted and thus up to two slope updates are signaled for a single chroma block.

### Encoder Approach

The proposed encoder approach performs an SATD based search for the best value of the slope update for Cr and a similar SATD based search for Cb. If either one results as a non-zero slope adjustment parameter, the combined slope adjustment pair (SATD based update for Cr, SATD based update for Cb) is included in the list of RD checks for the TU.

### 2.1.2 Gradient PDPC

In VVC, for a few scenarios, PDPC may not be applied due to the unavailability of the secondary reference samples. In these cases, a gradient based PDPC, extended from horizontal/vertical mode, is applied. The PDPC weights (wT/wL) and nScale parameter for determining the decay in PDPC weights with respect to the distance from left/top boundary are set equal to corresponding parameters in horizontal/vertical mode, respectively. When the secondary reference sample is at a fractional sample position, bilinear interpolation is applied.

### 2.1.3 Secondary MPM

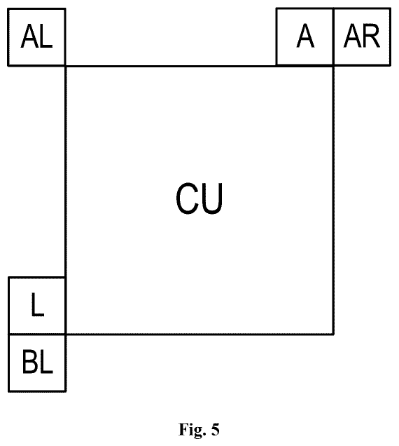

Secondary MPM lists is introduced. The existing primary MPM (PMPM) list consists of 6 entries and the secondary MPM (SMPM) list includes 16 entries. A general MPM list with 22 entries is constructed first, and then the first 6 entries in this general MPM list are included into the PMPM list, and the rest of entries form the SMPM list. The first entry in the general MPM list is the Planar mode. The remaining entries are composed of the intra modes of the left (L), above (A), below-left (BL), above-right (AR), and above-left (AL) neighbouring blocks as shown in FIG. 5, the directional modes with added offset from the first two available directional modes of neighbouring blocks, and the default modes.

If a CU block is vertically oriented, the order of neighbouring blocks is A, L, BL, AR, AL; otherwise, it is L, A, BL, AR, AL.

FIG. 5 illustrates neighbouring blocks (L, A, BL, AR, AL) used in the derivation of a general MPM list.

A PMPM flag is parsed first, if equal to 1 then a PMPM index is parsed to determine which entry of the PMPM list is selected, otherwise the SPMPM flag is parsed to determine whether to parse the SMPM index or the remaining modes.

### 2.1.4 Reference Sample Interpolation and Smoothing for Intra-Prediction

The 4-tap cubic interpolation is replaced with a 6-tap cubic interpolation filter, for the derivation of predicted samples from the reference samples.

For reference sample filtering, a 6-tap gaussian filter is applied for larger blocks (W>=32 and H>=32), existing VVC 4-tap gaussian interpolation filter is applied otherwise. The extended intra reference samples are derived using the 4-tap interpolation filter instead of the nearest neighbor rounding.

### 2.1.5 Decoder Side Intra Mode Derivation (DIMD)

When DIMD is applied, two intra modes are derived from the reconstructed neighbor samples, and those two predictors are combined with the planar mode predictor with the weights derived from the gradients. The division operations in weight derivation are performed utilizing the same lookup table (LUT) based integerization scheme used by the CCLM. For example, the division operation in the orientation calculation

$$Orient = {G}_{y} / {G}_{x}$$

is computed by the following LUT-based scheme:

$$\begin{matrix}x = Floor ( Log 2 ( Gx ) ) \\ normDiff = ( ( Gx ≪ 4 ) ≫ x ) \& 15 \\ x += ( 3 + ( normDiff != 0 ) ? 1 : 0 ) \\ Orient = ( {Gy}^{*} ( DivSig Table [ normDiff ] \vert 8 ) + ( 1 ≪ ( x - 1 ) ) ) ≫ x\end{matrix}$$

$$where$$

$$DivSig Table [ 16 ] = \{ 0 , 7 , 6 , 5 , 5 , 4 , 4 , 3 , 3 , 2 , 2 , 1 , 1 , 1 , 1 , 0 \} .$$

Derived intra modes are included into the primary list of intra most probable modes (MPM), so the DIMD process is performed before the MPM list is constructed. The primary derived intra mode of a DIMD block is stored with a block and is used for MPM list construction of the neighboring blocks.

### 2.1.5.1DIMD Chroma Mode

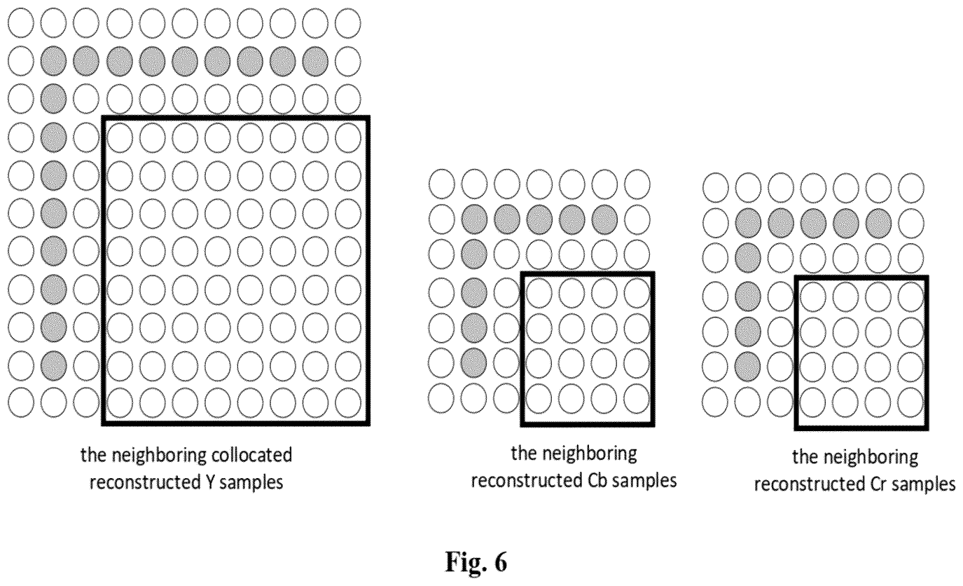

The DIMD chroma mode uses the DIMD derivation method to derive the chroma intra prediction mode of the current block based on the neighboring reconstructed Y, Cb and Cr samples in the second neighboring row and column as shown in FIG. 6. Specifically, a horizontal gradient and a vertical gradient are calculated for each collocated reconstructed luma sample of the current chroma block, as well as the reconstructed Cb and Cr samples, to build a HoG. Then the intra prediction mode with the largest histogram amplitude values is used for performing chroma intra prediction of the current chroma block.

FIG. 6 illustrates neighboring reconstructed samples used for DIMD chroma mode.

When the intra prediction mode derived from the DIMD chroma mode is the same as the intra prediction mode derived from the DM mode, the intra prediction mode with the second largest histogram amplitude value is used as the DIMD chroma mode. A CU level flag is signaled to indicate whether the proposed DIMD chroma mode is applied.

### 2.1.6 Fusion of Chroma Intra Prediction Modes

The DM mode and the four default modes can be fused with the MMLM_LT mode as follows:

$$pred = ( w 0 * pred 0 + w 1 * pred 1 + ( 1 ≪ ( shift - 1 ) ) ) ≫ shift$$

where pred0 is the predictor obtained by applying the non-LM mode, pred1 is the predictor obtained by applying the MMLM_LT mode and pred is the final predictor of the current chroma block. The two weights, w0 and w1 are determined by the intra prediction mode of adjacent chroma blocks and shift is set equal to 2. Specifically, when the above and left adjacent blocks are both coded with LM modes, {w0, w1}={1, 3}; when the above and left adjacent blocks are both coded with non-LM modes, {w0, w1}={3, 1}; otherwise, {w0,w1}={2, 2}.

For the syntax design, if a non-LM mode is selected, one flag is signaled to indicate whether the fusion is applied. This method only applies to I slices.

### 2.1.7 Intra Template Matching

Intra template matching prediction (Intra TMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

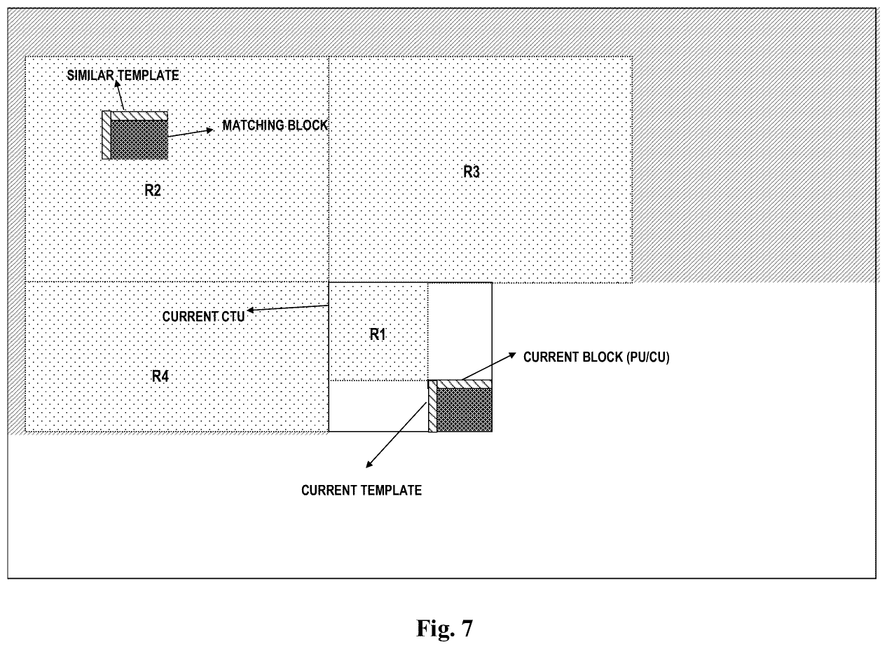

The prediction signal is generated by matching the L-shaped causal neighbor of the current block with another block in a predefined search area in FIG. 7 consisting of:
R1: current CTU,
R2: top-left CTU,
R3: above CTU,
R4: left CTU.

Sum of absolute differences (SAD) is used as a cost function.

Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:

$$\begin{matrix}SearchRange\_w = a * BlkW , \\ SearchRange\_h = a * BlkH .\end{matrix}$$

Where ‘a’ is a constant that controls the gain/complexity trade-off. In practice, ‘a’ is equal to 5.

FIG. 7 illustrates an intra template matching search area used.

The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.

### 2.1.8 Fusion for Template-Based Intra Mode Derivation (TIMD)

For each intra prediction mode in MPMs, The SATD between the prediction and reconstruction samples of the template is calculated. First two intra prediction modes with the minimum SATD are selected as the TIMD modes. These two TIMD modes are fused with the weights after applying PDPC process, and such weighted intra prediction is used to code the current CU. Position dependent intra prediction combination (PDPC) is included in the derivation of the TIMD modes.

The costs of the two selected modes are compared with a threshold, in the test the cost factor of 2 is applied as follows:

$$costMode 2 < 2 * costMode 1.$$

If this condition is true, the fusion is applied, otherwise the only model is used.

Weights of the modes are computed from their SATD costs as follows:

$$\begin{matrix}weight 1 = costMode 2 / ( cos Mode 1 + costMode 2 ) , \\ weight 2 = 1 - weight 1.\end{matrix}$$

The division operations are conducted using the same lookup table (LUT) based integerization scheme used by the CCLM.

### 2.1.9 Combination of CIIP with TIMD and TM Merge

In CIIP mode, the prediction samples are generated by weighting an inter prediction signal predicted using CIIP-TM merge candidate and an intra prediction signal predicted using TIMD derived intra prediction mode. The method is only applied to coding blocks with an area less than or equal to 1024.

The TIMD derivation method is used to derive the intra prediction mode in CIIP. Specifically, the intra prediction mode with the smallest SATD values in the TIMD mode list is selected and mapped to one of the 67 regular intra prediction modes.

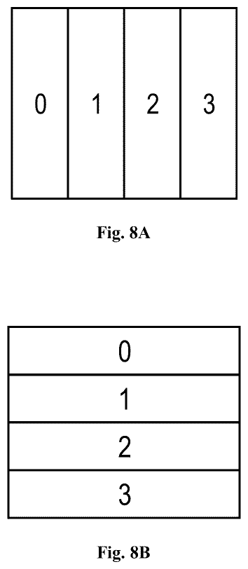

FIG. 8A and FIG. 8B illustrate a division method for angular modes, respectively.

In addition, it is also proposed to modify the weights (wIntra, wInter) for the two tests if the derived intra prediction mode is an angular mode. For near-horizontal modes (2<=angular mode index<34), the current block is vertically divided as shown in FIG. 8A; for near-vertical modes (34<=angular mode index<=66), the current block is horizontally divided as shown in FIG. 8B.

The (wIntra, wInter) for different sub-blocks are shown in Table 1.

TABLE 1
The modified weights used for angular modes.

| The sub-block index | (wIntra, wInter) |
|---|---|
| 0 | (6, 2) |
| 1 | (5, 3) |
| 2 | (3, 5) |
| 3 | (2, 6) |

With CIIP-TM, a CIIP-TM merge candidate list is built for the CIIP-TM mode. The merge candidates are refined by template matching. The CIIP-TM merge candidates are also reordered by the ARMC method as regular merge candidates. The maximum number of CIIP-TM merge candidates is equal to two.

### 2.1.10 Extended Multiple Reference Line (MRL) List

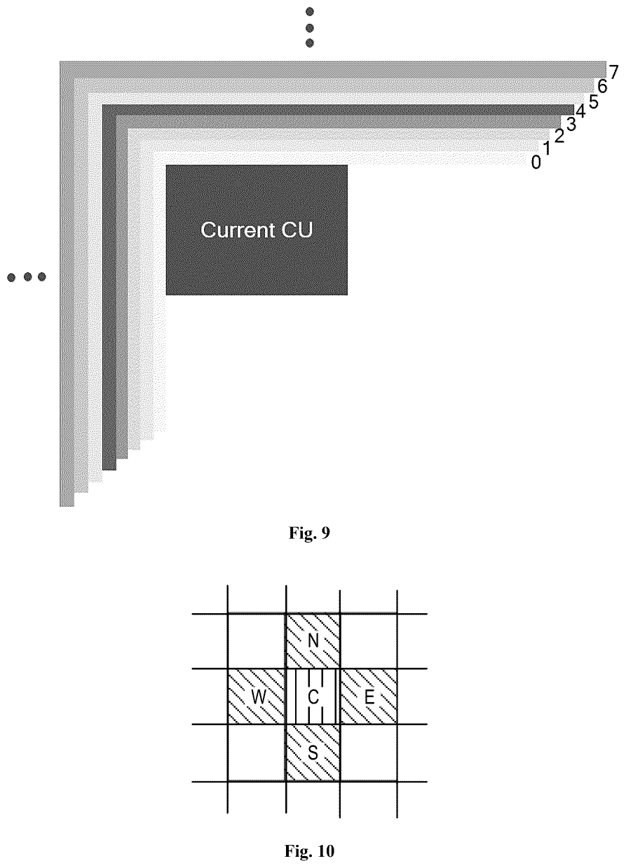

MRL list in VVC is extended to include more reference lines for intra prediction. The extended reference line list consists of line indices {1, 3, 5, 7, 12} as shown FIG. 9. FIG. 9 illustrates an extended MRL candidate list. For template-based intra mode derivation (TIMD), instead of the full MRL candidate list, only the first two reference line candidates, i.e., {1, 3}, are used.

### 2.1.11 Convolutional Cross-Component Intra Prediction Model

In this method convolutional cross-component model (CCCM) is applied to predict chroma samples from reconstructed luma samples in a similar spirit as done by the current CCLM modes. As with CCLM, the reconstructed luma samples are down-sampled to match the lower resolution chroma grid when chroma sub-sampling is used.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

### 2.1.11.1 Convolutional Filter

The convolutional 7-tap filter consist of a 5-tap plus sign shape spatial component, a nonlinear term and a bias term. The input to the spatial 5-tap component of the filter consists of a center (C) luma sample which is collocated with the chroma sample to be predicted and its above/north (N), below/south (S), left/west (W) and right/east (E) neighbors as illustrated below.

FIG. 10 illustrates a spatial part of the convolutional filter.

The nonlinear term P is represented as power of two of the center luma sample C and scaled to the sample value range of the content:

$$P = ( C * C + midVal ) ≫ bit Depth .$$

That is, for 10-bit content it is calculated as:

$$P = ( C * C + 512 ) ≫ 10.$$

The bias term B represents a scalar offset between the input and output (similarly to the offset term in CCLM) and is set to middle chroma value (512 for 10-bit content).

Output of the filter is calculated as a convolution between the filter coefficients ci and the input values and clipped to the range of valid chroma samples:

$$pred Chroma Val = {c}_{0} C + {c}_{1} N + {c}_{2} S + {c}_{3} E + {c}_{4} W + {c}_{5} P + {c}_{6} B .$$

### 2.1.11.2 Calculation of Filter Coefficients

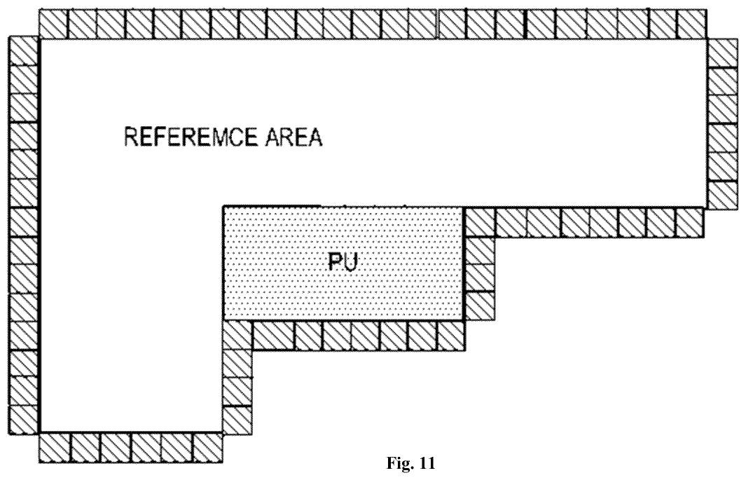

The filter coefficients ci are calculated by minimising MSE between predicted and reconstructed chroma samples in the reference area. FIG. 11 illustrates the reference area which consists of 6 lines of chroma samples above and left of the PU. FIG. 11 illustrates the reference area (with its paddings) used to derive the filter coefficients. Reference area extends one PU width to the right and one PU height below the PU boundaries. Area is adjusted to include only available samples. The extensions to the area shown in blue are needed to support the “side samples” of the plus shaped spatial filter and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

### 2.1.11.3 Gradient Linear/Non-Linear/Polynomial Regression Model

Compared with the CCLM, instead of down-sampled luma values, the GLM utilizes luma sample gradients to derive the linear/non-linear/polynomial regression model. Specifically, when the GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β .$$

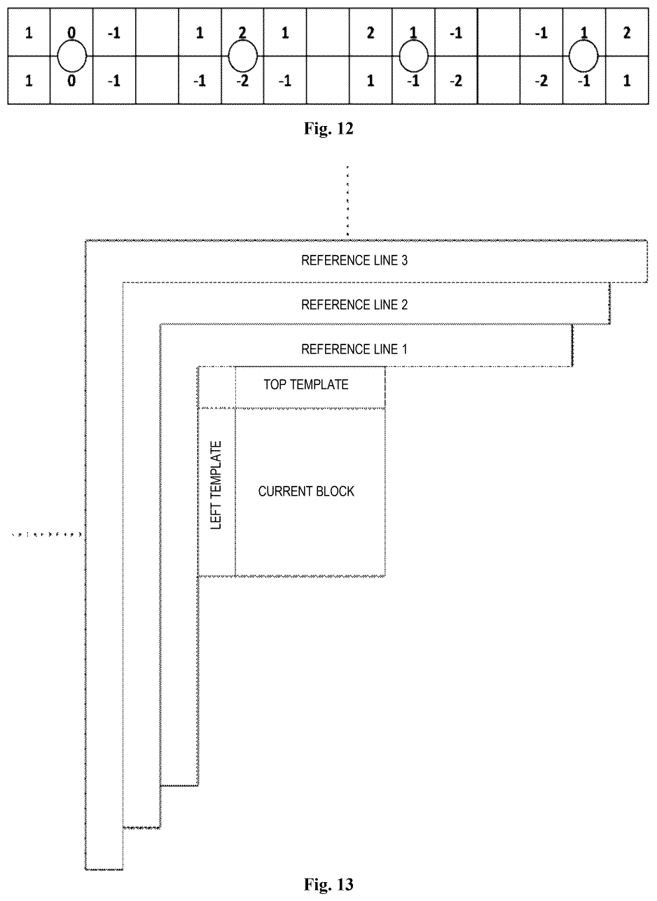

For signaling, when the CCLM mode is enabled to the current CU, two flags are signaled separately for Cb and Cr components to indicate whether GLM is enabled to each component; if the GLM is enabled for one component, one syntax element is further signaled to select one of 4 gradient filters for the gradient calculation.
Four gradient filters are enabled for the GLM, as illustrated in FIG. 12, which illustrates four Sobel based gradient patterns for GLM.

### 2.1.11.4 Gradient Linear/Non-Linear/Polynomial Regression Model with Luma Value

In ECM-6.0, GLM utilizes the gradient of luma samples to predict a chroma sample as:

$${pred}_{C} ( i , j ) = α \cdot G ( i , j ) + β ,$$

where pred_{c}(i,j) represents the predicted value of a chroma sample, G(i,j) represents the gradient of the corresponding reconstructed luma samples, and the linear/non-linear/polynomial regression model parameters α and β are derived by adjacent reconstructed samples based on the linear minimum mean square error (LMMSE) method as CCLM.

In the tests, a new GLM mode is evaluated that a chroma sample is predicted based on both the gradient G(i,j) of luma samples and the reconstructed value

$${rec}_{L}^{′} ( i , j )$$

of the down-sampled luma sample with different parameters:

$${pred}_{C} ( i , j ) = {α}_{0} \cdot G ( i , j ) + {α}_{1} \cdot {rec}_{L}^{′} ( i , j ) + {α}_{2} \cdot mid Value ,$$

where the model parameters α₀, α₁ and α₂ are derived from 6 rows and columns adjacent samples based on the LDL decomposition method as the CCCM mode in ECM-6.0.

For signalling, one flag is signaled to indicate whether GLM is enabled to both Cb and Cr components, and the syntax element that indicates the gradient pattern is coded by truncated unary code.

The original GLM mode is reserved and the new GLM mode is signalled as an additional mode by signaling one extra flag in the bitstream.

### 2.1.11.5 Bitstream Signalling

Usage of the mode is signalled with a CABAC coded PU level flag. One new CABAC context was included to support this. When it comes to signalling, CCCM is considered a sub-mode of CCLM. That is, the CCCM flag is only signalled if intra prediction mode is LM_CHROMA.

### 2.1.12 Template-Based Multiple Reference Line Intra Prediction

In template-based multiple reference line intra prediction, instead of signalling the reference line and the intra mode directly, an index to the candidate list is coded to indicate which combination of the reference line and prediction mode is used for coding the current block, a truncated Golomb-Rice coding with a divisor 4 is employed to code selected combinations from the combination list.

The list of 20 candidates is constructed by combining an MPM with the reference line {1, 3, 5, 7, 12}.

The MPM list construction is modified comparing to the regular intra MPM as follows:
PLANAR mode is excluded from the intra-prediction-mode candidate list,
DC mode is added after the 5 neighboring modes and DIMD modes,
The delta angles from ±1 to ±4 added to the already included to the list angular modes.

There are 5×10=50, which are sorted in the ascending order by SAD cost in the template area shown in FIG. 13.

Since the extended reference line starts from reference line 1, the area covered by reference line 0 is used for the template cost calculation. The 20 combinations with the least SAD cost form the candidate list.

### 2.1.13 Intra Prediction Fusion

In this test, intra prediction is formed by fusion intra prediction derived from different reference lines as follows:
For angular intra prediction modes including the single mode case of TIMD and DIMD, the proposed method derives intra prediction by weighting intra predictions obtained from multiple reference lines represented as p_{fusion}=w₀pₗᵢₙₑ+w₁pₗᵢₙₑ₊₁, where pₗᵢₙₑ is the intra prediction from the default reference line and pₗᵢₙₑ₊₁ is the prediction from the line above the default reference line. The weights are set as w₀=¾ and w₁=¼.
For TIMD mode with blending, pₗᵢₙₑ is used for the 1^{st} mode (w₀=1, w₁=0) and pₗᵢₙₑ₊₁ is used for the 2^{nd} mode (w₀=0, w₁=1).
For DIMD mode with blending, the number of predictors selected for a weighted average is increased from 3 to 6.

Intra prediction fusion is applied to luma blocks when angular intra mode has non-integer slope (required reference samples interpolation) and the block size is greater than 16, it is used with MRL and not applied for ISP coded blocks. PDPC is applied for the intra prediction mode using the closest to the current block reference line.

### 2.1.14 IntraTMP Adaptation for Camera-Captured Content

In the test, IntraTMP is enabled for camera-captured content with the speedup method applied, where the search area is sub-sampled by a factor of 2, which reduces the template matching search by a factor of 4. After finding the best match, a second refinement process is performed in which another template matching search is performed around the best match with a reduced search range defined as min(width, height)/2 of the current block.

### 2.2 on LIC, AMVP-MERGE, and Adaptive DMVR Mode

The detailed embodiments below should be considered as examples to explain general concepts. These embodiments should not be interpreted in a narrow way. Furthermore, these embodiments can be combined in any manner.

The terms ‘video unit’ or ‘coding unit’ or ‘block’ may represent a coding tree block (CTB), a coding tree unit (CTU), a coding block (CB), a CU, a PU, a TU, a PB, a TB.

In this disclosure, regarding “a block coded with mode N”, here “mode N” may be a prediction mode (e.g., MODE_INTRA, MODE_INTER, MODE_PLT, MODE_IBC, and etc.), or a coding technique (e.g., AMVP, Merge, SMVD, BDOF, PROF, DMVR, AMVR, TM, Affine, CIIP, GPM, GEO, TPM, MMVD, BCW, HMVP, SbTMVP, and etc.).

In this disclosure, “a two-direction-DMVR” may indicate regular DMVR which refines both L0 and L1 motion vectors, as elaborated in section 2.1.14. Moreover, “a one-direction-DMVR” may indicate a DMVR process which refines either L0 or L1 motion vector only, such as adaptive DMVR elaborated in section 2.1.23.

In the following discussion, LIC parameters may refer to the two parameters (such as a slope parameter “a” and a bias parameter “b”) derived based on a linear/non-linear/polynomial regression model, which is used to map the neighboring samples of current block and the neighboring samples of temporally collocated block (e.g., temporally collocated block may be pointed by the motion vector or a rounded motion vector of the current block). Furthermore, the LIC parameters may be used to estimate the prediction values of samples inside the current video unit.

In the following discussion, the AMVP mode may be regular AMVP mode, affine-AMVP mode, and/or SMVD mode, and/or AMVP-MERGE mode.

It is noted that the terminologies mentioned below are not limited to the specific ones defined in existing standards. Any variance of the coding tool is also applicable.

### 2.2.1 to Tackle the First Problem, the Following Methods are Proposed

a. It is proposed to support multiple MVD/MV precisions for the AMVP-MERGE mode.
   i. In one example, the supported precision candidates may be the same as those used for the normal AMVP mode, e.g., for non-affine case, half-pel, ¼-pel, 1-pel, 4-pel are applied; for affine case, 1/16-pel, ⅛-pel, ¼-pel are applied.
   ii. In another example, at least one of the supported precision candidates may be different from that used for normal AMVP mode.
b. For example, the motion vector difference (e.g., MVD) of the AMVP side of an AMVP-MERGE mode may be coded with other precisions in addition to ¼ pel resolution.
   i. For example, the MVD value may be of 4-pel precision.
   ii. For example, the MVD value may be of 1-pel precision.
   iii. For example, the MVD value may be of half-pel precision.
   iv. For example, the MVD value may be of ⅛-pel precision.
   v. For example, the MVD value may be of 1/16-pel precision.
c. For example, a second interpolation filter (e.g., Y-tap filter such as Y=6) in addition to a first interpolation filter (e.g., X-tap filter such as X=8 or 12) may be used for motion compensation.
   i. For example, when to use the second interpolation filter for an AMVP-MERGE coded block may be dependent on the MVD prediction and/or the final MV precision.
   ii. For example, when the signalled MVD is ½-pel precision and the final MV is also ½-pel precision, the second interpolation filter may be used. Otherwise, the first interpolation filter may be used.
   iii. In one example, the second interpolation filter used in the AMVP-MERGE mode may be the same as that used for the normal AMVP mode (e.g., the one used for the ½-pel precision).
   iv. Alternatively, the second interpolation filter used in the AMVP-MERGE mode may be different from that used for the normal AMVP mode (e.g., the one used for the ½-pel precision).
d. Alternatively, half-pel MVD precision may not be allowed to be used for AMVP-MERGE mode.
e. For example, at least one syntax element (e.g., flag and/or parameter index) may be signalled at block level to indicate which motion vector precision is used to code/signal the MVD value and/or MV of an AMVP-MERGE mode coded video unit.
   i. Furthermore, the signalled MVD at any resolution may be converted to an internal precision (e.g., 1/16 pel resolution) for latter procedures such as motion compensation and etc.

### 2.2.2 to Tackle the Second Problem, the Following Methods are Proposed

a. In one example, the prediction unit generated based on AMVP-MERGE mode may be used as an MHP hypotheses.
   i. For example, the AMVP-MERGE mode prediction block may be used as the base hypothesis of an MHP block.
   ii. For example, syntax elements/structure related to MHP hypothesis data (e.g., whether there is additional hypothesis associated with the AMVP-MERGE coded video unit; if there is, AMVP or MERGE based MHP additional hypothesis is used, etc.) may be signalled in the bitstream right after a video unit is identified to be an AMVP-MERGE mode coded video unit.
   iii. For example, an AMVP-MERGE prediction block may be used as an additional hypothesis of an MHP block.
   iv. For example, additional hypothesis of an MHP block may be generated based on an AMVP-MERGE motion candidate.
      1) For example, in such case, syntax elements related to this AMVP-MERGE motion candidate (e.g., which side is AMVP/MERGE coded, reference index of the AMVP side, MVD value for the AMVP side, and/or MVP index of the AMVP side) may be signalled in the multiple hypothesis data structure.
   v. For example, whether LIC is used for an AMVP-MERGE coded additional hypothesis may be inherited from the usage of LIC of the base hypothesis.
      1) For example, if the base hypothesis is LIC coded, the AMVP-MERGE coded additional hypothesis is LIC coded without signalling the usage of the LIC of such additional hypothesis.
      2) Alternatively, if the base hypothesis is NOT LIC coded, the AMVP-MERGE coded additional hypothesis is NOT LIC coded without signalling the usage of the LIC of such additional hypothesis.
   vi. For example, whether LIC is used for an AMVP-MERGE coded hypothesis (base and/or additional hypothesis) may be dependent on the usage of LIC of the merge side of the AMVP-MERGE candidate.
      1) For example, given that a certain AMVP-MERGE candidate is composed of a uni-merge candidate in one side (L0 or L1) and a uni-AMVP candidate in the other side (L1 or L0),
         a. For example, the usage of LIC for such AMVP-MERGE candidate may be inherited from its merge candidate.
         b. For example, if the merge candidate uses LIC, then LIC may be used for the AMVP-MERGE coded prediction block.
   vii. Alternatively, the usage of LIC for an AMVP-MERGE coded hypothesis may be signalling in the bitstream.

### 2.2.3 to Tackle the Third Problem, the Following Methods are Proposed

a. For example, an AMVP-MERGE candidate may be used for one or more of the following coding modes.
   i. CIIP mode (and/or its variants, e.g., regular CIIP, CIIP-PDPC, CIIP-TM, etc).
   ii. MMVD mode (and/or its variants, e.g., regular MMVD, affine MMVD, etc).
   iii. MHP mode (and/or its variants, e.g., MHP base hypothesis, and/or MHP additional hypothesis, etc).
   iv. GPM mode (and/or its variants, e.g., regular GPM, GPM-TM, GPM-MMVD, GPM-Inter-Intra, etc).
b. For example, an AMVP-MERGE candidate may be firstly refined by a decoder side motion vector refinement process (e.g., TM or DMVR based motion vector refinements), then used for a second coding mode (e.g., such as listed in the above sub-bullet).
c. For example, AMVP-MERGE candidates may be inserted to another candidate list.
   i. For example, AMVP-MERGE candidates may be inserted to the regular merge candidate list.
      1) For example, AMVP-MERGE candidate may be used for regular merge mode and/or its variants.
      2) For example, AMVP-MERGE candidate may be used for MMVD mode and/or its variants.
      3) For example, AMVP-MERGE candidate may be used for CIIP mode and/or its variants.
      4) For example, AMVP-MERGE candidate may be used for MHP mode and/or its variants.
      5) For example, AMVP-MERGE candidate may be used for GPM mode and/or its variants.
   ii. For example, AMVP-MERGE candidates may be inserted to the regular TM merge candidate list.
      1) For example, AMVP-MERGE candidate may be used for regular TM merge mode and/or its variants.
   iii. Additionally, furthermore, the AMVP-MERGE candidate may be inserted to another prediction list after the original candidates of that prediction list.
d. For example, AMVP-MERGE candidates may be reordered based on a decoder derived method (through TM or DMVR based cost evaluation), then M of them would be selected to be added to a second candidate list (such as regular merge candidate list, regular TM merge candidate list).
   i. Additionally, furthermore, more than one AMVP-MERGE candidates may be reordered together.
   ii. Alternatively, a first candidate from the first AMVP-MERGE prediction list and a second candidate from the second prediction list may be reordered together.
e. For example, once an AMVP-MERGE candidate is used for a coding block, extra syntax elements may be signalled specifying the prediction direction (L0 or L1) of the AMVP part, and/or the reference picture index of the selected AMVP candidate, and/or the motion vector predictor index of the selected AMVP candidate, and/or the motion vector difference associated with the AMVP motion vector predictor.
   i. Alternatively, the motion vector predictor index of the AMVP side of an AMVP-MERGE candidate may not be signalled (e.g., it may be selected by a decoder side method through TM or DMVR based cost evaluation).
f. Alternatively, once an AMVP-MERGE candidate is used, extra syntax element(s) may be signalled specifying the predictor index of the merge candidate.
   i. Alternatively, the motion vector predictor index of the merge side of an AMVP-MERGE candidate may not be signalled (e.g., it may be selected by a decoder side method through TM or DMVR based cost evaluation).
g. In one example, the merge part of AMVP-MERGE mode may be firstly refined by a decoder side motion vector refinement process (such as TM or DMVR) before generating a AMVP-MERGE candidate.
h. In one example, the AMVP part of AMVP-MERGE mode may be firstly refined by a decoder side motion vector refinement process (such as TM or DMVR) before generating a AMVP-MERGE candidate.

### 2.2.4 to Tackle the Fourth Problem, the Following Methods are Proposed

a. For example, an adaptive DMVR motion candidate may be used for one or more of the following coding modes.
   i. CIIP mode (and/or its variants, e.g., regular CIIP, CIIP-PDPC, CIIP-TM, etc).
   ii. MMVD mode (and/or its variants, e.g., regular MMVD, affine MMVD, etc).
   iii. MHP mode (and/or its variants, e.g., MHP base hypothesis, and/or MHP additional hypothesis, etc).
   iv. GPM mode (and/or its variants, e.g., regular GPM, GPM-TM, GPM-MMVD, GPM-Inter-Intra, etc).
   v. AMVP mode (and/or its variants, e.g., regular AMVP, SMVD, AMVP-MERGE, affine AMVP, etc).
b. For example, an adaptive DMVR motion candidate may be firstly refined by a decoder side motion vector refinement process (e.g., TM or DMVR based motion vector refinements), then used for a second coding mode (e.g., such as listed in the above sub-bullet).
c. For example, when an adaptive DMVR motion candidate is used for an AMVP mode,
   i. The DMVR motion candidate may refer to a motion vector pair contains both L0 and L1 motion vectors, and/or, both L0 and L1 reference picture indexes.
   ii. It may be used as an MVP candidate.
   iii. The candidate index of the DMVR motion candidate (rather than the L0 and L1 motion vector predictor indexes, and L0 and L1 reference picture indexes) may be signalled for the AMVP mode in the bitstream.
   iv. The reference picture index of one prediction direction (L0 or L1) may be signalled for the AMVP mode, and the reference picture index of the other prediction direction (L1 or L0) may be inferred (e.g., according to the DMVR condition).
d. For example, adaptive DMVR motion candidates may be inserted to another candidate list.
   i. For example, adaptive DMVR motion candidates may be inserted to the regular merge candidate list.
      1) For example, adaptive DMVR motion candidate may be used for regular merge mode and/or its variants.
      2) For example, adaptive DMVR motion candidate may be used for MMVD mode and/or its variants.
      3) For example, adaptive DMVR motion candidate may be used for CIIP mode and/or its variants.
      4) For example, adaptive DMVR motion candidate may be used for MHP mode and/or its variants.
      5) For example, adaptive DMVR motion candidate may be used for GPM mode and/or its variants.
   ii. For example, adaptive DMVR motion candidates may be inserted to the regular TM merge candidate list.
      1) For example, adaptive DMVR motion candidate may be used for regular TM merge mode and/or its variants.
   iii. Additionally, furthermore, the adaptive DMVR motion candidate may be inserted to another prediction list after the original candidates of that prediction list.
e. For example, adaptive DMVR motion candidates may be reordered based on a decoder derived method (through TM or DMVR based cost evaluation), then M of them would be selected to be added to a second candidate list (such as regular merge candidate list, regular TM merge candidate list).
   i. Additionally, furthermore, more than one adaptive DMVR motion candidates may be reordered together.
   ii. Alternatively, a first candidate from the first adaptive DMVR merge list and a second candidate from the second prediction list may be reordered together.

### 2.2.5 to Tackle the Fifth Problem, the Following Methods are Proposed

a. For example, the enabling/disabling of a first coding tool may be controlled by a second syntax element signalled at a syntax level higher than coding block level.
   i. For example, the syntax level higher than coding block level may indicate sequence level/group of pictures level/picture level/slice level/tile group level, such as in sequence header/picture header/SPS/VPS/DPS/DCI/PPS/APS/slice header/tile group header.
   ii. For example, a single coding tool may be controlled by the second syntax element.
   iii. For example, more than one coding tool may be controlled by the second syntax element.
   iv. For example, the first coding tool may be a prediction mode that utilizes a decoder side motion derivation method (such as AMVP-MERGE mode, etc.).
   v. For example, the second syntax elements may be an SPS/PPS/PH/SH flag specifying whether the decoder side motion derivation methods (such as DMVR and TM and etc.) is allowed or not.
   vi. For example, the second syntax elements may be an SPS/PPS/PH/SH flag specifying whether the decoder side motion vector refinement (such as DMVR and etc.) is allowed or not.
   vii. For example, the second syntax elements may be an SPS/PPS/PH/SH flag specifying whether the decoder side template matching (such as TM, and/or inter TM and etc.) is allowed or not.

### 2.2.6 about the LIC Parameter Derivation (e.g., as Illustrated in the Sixth Problem), Suppose the Linear/Non-Linear/Polynomial Regression Model Used for an LIC Coded Block is Based on at Least Two Parameters: A Slope Parameter “a” and a Bias Parameter “b”, and the Relationship Between the Neighboring Sample of the Current Block and the Neighboring Sample of the Temporally Collocated Block can be Represented by “reconTempNeigh=a*reconCurNeigh+b”, in which “reconTempNeigh” Denotes the Reconstruction/Prediction Value of the Neighboring Sample of the Temporally Collocated Block, and “reconCurNeigh” Denotes the Reconstruction/Prediction Value of the Neighboring Sample of the Current Block, the Following Methods are Proposed

a. For example, at least one adjustment factor may be applied to adjust at least one LIC parameter for an LIC model derivation.
   a. For example, the adjustment factor may be signalled/present in the bitstream.
   b. For example, the adjustment factor may be derived at both encoder and decoder.
b. For example, at least one syntax element (e.g., a syntax parameter, or index, or variable, or offset value, or integer) may be signalled at a video unit level for calculating at least one LIC parameter of at least one LIC model.
   a. For example, the video unit level may be PU/CU/block level.
      i. For example, furthermore, the video unit level may be sequence/group of pictures/picture/slice/tile group/PB/TB/CB/PU/TU/CU/VPDU/CTU/CTU row/slice/tile/sub-picture level.
   b. For example, the syntax element(s) may be used to adjust the value of at least one LIC parameter of at least one LIC model.
      i. For example, the syntax element(s) may be used as indicator(s) for adjustment factor(s).
      ii. Alternatively, the syntax element(s) may be used to represent/indicate the value of at least one LIC parameter.
      iii. For example, one indicator may be signalled to adjust the parameters of one LIC model.
   c. For example, the derivation of LIC parameters may be based on both decoder derived methods and the signalled syntax element.
   d. For example, the syntax element may be an indicator of an integer.
      i. For example, the value of the syntax element may be in the range of [−N, +N], for example, N=4.
      ii. For example, the LIC parameter may be directly derived based the integer.
   e. For example, the syntax element may be an indictor of an index.
      i. For example, according to the first value of the index, a second value may be derived from a (pre-defined) look-up-table for the LIC parameter derivation.
   f. For example, how many syntax elements are signalled may be dependent on how many linear/LIC model is used for the video unit (e.g., a coding block).
      i. For example, if M LIC models are used for the video unit, then M syntax elements may be signalled associated with the video unit.
c. For example, the prediction sample value derivation of an LIC coded video unit may be conducted based on an updated model: ValueAfter=a′*ValueBefore+b′, wherein a′=a+Delta, b′=b−Delta*funcD.
   a. For example, the updated model may be used to estimate/derive the prediction samples inside the current block.
      i. Alternatively, the updated model may be used to modulate the relationship between neighboring samples of the current block and neighboring samples of temporally collocated block.
   b. For example, “Delta” may be a slope adjustment/offset value of an LIC model.
      i. For example, at least one indictor of “Delta” may be signalled in the bitstream.
      ii. Alternatively, the value of “Delta” may be derived based on decoded information (e.g., decoded sample values, decoded prediction modes of neighboring/reference blocks).
      iii. For example, “Delta” may be an integer.
      iv. For example, “Delta” may be an integer in the range of [−N, +N], for example, N=4.
      v. For example, “Delta” may be a number/value/integer/constant/variable derived from an index on a look-up-table.
   c. For example, “funcD” may be calculated by averaging the reconstruction/prediction values of all available/appropriate/possible neighboring samples of the current block (or, all available/appropriate/possible neighboring samples of the temporally collocated block).
      i. For example, “funcD” may be calculated by averaging neighboring/reference samples from both Intra and Inter coded blocks.
         1. Alternatively, “funcD” may be calculated by averaging neighboring/reference samples from Inter coded blocks only.
      ii. For example, “funcD” may be calculated by averaging all available neighboring/reference samples located at the left and/or above side of the current block and/or temporally collocated block.
         1. Alternatively, only partial (e.g., neighboring the first top-left M×M unit, such as M=16 or 8 or 4 or 32) of such samples may be considered.
      iii. For example, (the neighboring samples of) the temporally collocated block may be retrieved/pointed by the block motion vector (or its variant).
         1. Alternatively, (the neighboring samples of) the temporally collocated block may be retrieved/pointed by a rounded block motion vector (e.g., rounded to integer-pel precision).
      iv. For example, the averaging process may be processed with (or without) a rounding factor.
      v. Alternatively, the averaging process may be replaced by other function such as summing up, etc.
   d. For example, the updated model (e.g., with adjustment) may be used/allowed for all LIC coded blocks.
      i. Alternatively, the updated model may be used/allowed for a certain kind of LIC coded blocks.
         1. For example, the “certain kind” may be determined based on the available/appropriate/possible neighboring samples (such as both left and above neighboring samples are available, or only left neighboring are available, or only above neighboring are available, etc.).
         2. For example, the “certain kind” may be determined based on the prediction mode (such as AMVP coded or MERGE coded, uni-prediction or bi-prediction, etc.).
      ii. Alternatively, only if both left and above reference samples are available/appropriate/possible for the video unit, the updated model may be used/allowed.
      iii. Alternatively, only if the video unit is uni-directional predicted, the updated model may be used/allowed.
d. The information of the adjustment for LIC or CCLM or MM-CCLM may be coded in a predictive way.
e. The information of the adjustment for LIC or CCLM or MM-CCLM may be coded with at least one context model.
   a. The context model may depend on coding information.
   b. Alternatively, it may be coded in a bypass way.
f. For example, the neighboring/reference samples used to derive the LIC model parameters may not be all available/appropriate/possible neighboring/reference samples from the left side and above side adjacent to the coding block and temporally collocated block.
   a. For example, it may refer to neighboring/reference samples from both Intra and Inter coded blocks.
      i. Alternatively, it may refer to neighboring/reference samples from Inter coded blocks only.
   b. For example, it may refer to neighboring/reference samples located at the left (or above) side of the current block and/or temporally collocated block.
      i. Alternatively, only partial (e.g., neighboring the first top-left MxM unit, such as M=16 or 8 or 4 or 32) of such samples may be considered.
   c. For example, (the neighboring samples of) the temporally collocated block may be retrieved/pointed by the block motion vector (or its variant).
      i. Alternatively, (the neighboring samples of) the temporally collocated block may be retrieved/pointed by a rounded block motion vector (e.g., rounded to integer-pel precision).
g. For example, whether to apply/allow the adjustment (e.g., the updated model) for a video unit may be dependent on coded information.
   a. For example, both original model (without adjustment) and updated model (with adjustment) may be used/allowed.
      i. Alternatively, only the updated model would be used/allowed.
   b. For example, whether to allow (or apply) the adjustment based LIC model updating, may be signalled in the bitstream.
      i. For example, it may be signalled at (at least) one video unit level such as sequence/group of pictures/picture/slice/tile group/PB/TB/CB/PU/TU/CU/VPDU/CTU/CTU row/slice/tile/sub-picture level.
   c. For example, whether to allow (or apply) the adjustment based LIC model updating, may be derived at both encoder and decoder sides.

### 2.2.7 Whether to and/or how to Apply the Adjustment for CCLM, MM-CCLM or LIC May Depend on Coding Information, Such as Block Dimensions, Coding Mode, (Transformed) Residuals, Transforms Etc

a. For example, the adjustment may not be applied if the width and/or height and/or size of the block is smaller than a threshold.

### 2.2.8 about the Signalling and Determination of LIC (e.g., as Illustrated in the Seventh Problem), the Following Methods are Proposed

a. For example, the LIC flag at a video unit level (e.g., CU/PU level LIC flag) may not be signalled but derived at both encoder and decoder sides.
   a. For example, the CU/PU level LIC flag for an AMVP coded block may not be signaled.
   b. For example, the CU/PU level LIC flag for an Affine AMVP coded block may not be signaled.
   c. For example, the CU/PU level LIC flag for an AMVP-MERGE coded block may not be signaled.
b. For example, whether or to use LIC for a video unit may be dependent on coded information (e.g., decoder derived methods).
   a. For example, LIC flag at video unit level may be implicit derived at both encoder and decoder sides.
      i. For example, the CU/PU level LIC flag for a non-merge (such as AMVP, and/or affine AMVP) coded block may be implicit derived.
      ii. For example, the CU/PU level LIC flag for a merge (and/or its variants such as TM, BM, MHP, ADMVR, CIIP, GPM, sbTMVP, Affine Merge, etc.) coded block may be implicit derived.
      iii. For example, the implicit derivation may be based on decoder derived methods.
      iv. For example, the implicit derivation may be based on template matching.
      v. For example, the implicit derivation may be based on bilateral matching.
   b. For example, decoder derived costs/errors/distortions may be calculated for both non-LIC and LIC cases, and the one with less cost/error/distortion is determined as the coding method used for the video unit.
      i. For example, template (and/or bilateral) matching costs may be calculated for LIC coded video unit and non-LIC coded video unit, respectively.
      ii. For example, the costs/errors/distortions are derived by neighboring samples and/or reference samples temporally (collocated) in the reference pictures.
      iii. For example, the costs/errors/distortions are not derived by current block samples in the current picture.
   c. For example, the coded information used for LIC mode may be neighboring/reference samples from both Intra and Inter coded blocks.
      i. Alternatively, the coded information may be neighboring/reference samples from Inter coded blocks only.
   d. For example, the coded information used for LIC mode may be all available neighboring/reference samples located at the left and/or above side of the current block and/or temporally collocated block.
      i. Alternatively, only partial (e.g., neighboring the first top-left MxM unit, such as M=16 or 8 or 4 or 32) of such samples may be considered.
   e. For example, the temporally collocated block may be retrieved/pointed by the block motion vector (or its variant).
      i. Alternatively, the temporally collocated block may be retrieved/pointed by a rounded block motion vector (e.g., rounded to integer-pel precision).
c. For example, the merge index of an LIC coded merge block may not be signalled (e.g., derived at both encoder and decoder).
   a. For example, the motion (e.g., motion vector, reference index, prediction direction, etc) of the LIC coded merge block may be derived at both encoder and decoder sides.
   b. For example, multiple template (and/or bilateral) matching costs/errors/distortions may be calculated for all (or multiple, or pre-defined partial) available/possible/appropriate merge candidates, respectively. The one with minimum cost/error/distortion is determined as the motion used for the video unit.
      i. For example, the template is constructed by neighboring samples and/or reference samples temporally (collocated) in the reference pictures.
      ii. For example, the template is not constructed by current block samples in the current picture.
      iii. For example, the template is constructed with samples without LIC.
      iv. For example, the template is constructed with samples with LIC.
d. For example, a best LIC parameter set (such as a and b computed by least square fitting methods) may be determined from more than one set of LIC parameters.
   a. For example, more than one set of LIC parameters may be appropriate for an LIC coded video unit.
   b. For example, which LIC parameter set is used for the video unit may be derived at both encoder and decoder sides.
      i. Alternatively, a syntax element (e.g., an index) may be signalled specifying the LIC parameter set used for the video unit.
   c. For example, multiple template (and/or bilateral) matching costs/errors/distortions may be calculated for all appropriate sets of LIC parameters, respectively. The one with minimum cost/error/distortion is determined as the LIC parameter set used for the video unit.
      i. For example, the template is constructed by neighboring samples and/or reference samples temporally (collocated) in the reference pictures.
      ii. For example, the template is not constructed by current block samples in the current picture.

### General

### 2.2.9 Whether to and/or how to Apply the Disclosed Methods Above May be Signalled at Sequence Level/Group of Pictures Level/Picture Level/Slice Level/Tile Group Level, Such as in Sequence Header/Picture Header/SPS/VPS/DPS/DCI/PPS/APS/Slice Header/Tile Group Header

### 2.2.10 Whether to and/or how to Apply the Disclosed Methods Above May be Signalled at PB/TB/CB/PU/TU/CU/VPDU/CTU/CTU Row/Slice/Tile/Sub-Picture/Other Kinds of Region Contain More than One Sample or Pixel

### 2.2.11 Whether to and/or how to Apply the Disclosed Methods Above May be Dependent on Coded Information, Such as Block Size, Colour Format, Single/Dual Tree Partitioning, Colour Component, Slice/Picture Type

### 3 Problems

There are several issues in the existing video coding techniques, which would be further improved for higher coding gain.
1. In ECM-7.0, the CCLM prediction mode is applied with a slope adjustment method. However, division operations are used in the method, which may not be implementation friendly.
2. In ECM-7.0, mean removal is used in LIC and DMVR related tools. However, mean removal may be undesirable as it introduces an additional pipeline stage.
3. In ECM-7.0, LDL decomposition is used in CCCM and GLM, while least square based method is used for CCLM, MMLM, LIC. Such design may be improved.

### 4 Detailed Solutions

The detailed embodiments below should be considered as examples to explain general concepts. These embodiments should not be interpreted in a narrow way. Furthermore, these embodiments can be combined in any manner.

The terms ‘video unit’ or ‘coding unit’ may represent a picture, a slice, a tile, a coding tree block (CTB), a coding tree unit (CTU), a coding block (CB), a CU, a PU, a TU, a PB, a TB.

The terms ‘block’ may represent a coding tree block (CTB), a coding tree unit (CTU), a coding block (CB), a CU, a PU, a TU, a PB, a TB.

It is noted that the terminologies mentioned below are not limited to the specific ones defined in existing standards. Any variance of the coding tool is also applicable.

### 4.1 about the Division-Free Operation of Linear/Non-Linear/Polynomial Regression Model Slope Adjustment and Related Issues (e.g., the First Problem), the Following Methods are Proposed

a. For example, at least one of the following methods may be designed based on a linear/non-linear/polynomial regression model:
   a. A cross-component method that builds relationship between luma block samples and chroma block samples.
   b. An inter-prediction method that builds relationship between current block/template/area samples and reference block/template/area samples.
   c. An intra-prediction method that builds relationship between current block/template/area samples and reference block/template/area samples.
   d. An intra/inter-prediction method that builds relationship between prediction values and reconstruction values of reference/template/neighboring samples.
   e. An SCC-prediction method that builds relationship between current block/template/area samples and reference block/template/area samples.
   f. template matching (and/or its variants) based method.
   g. template cost (and/or its variants) based method.
   h. template (and/or its variants) based method.
   i. fusion/blending based method (such as blending weights derivation of TIMD/DIMD/CIIP/GPM/SGPM/MHP/BCW/chroma fusion/luma fusion, and etc.).
   j. CCLM and/or its variants.
   k. MMLM and/or its variants.
   l. CCCM and/or its variants.
   m. GLM and/or its variants.
   n. LIC and/or its variants.
   o. intraTMP and/or its variants.
b. A linear/non-linear/polynomial regression model may be updated based on slope adjustment parameter(s), in which the slope adjustment parameter is derived from division-free operations.
   a. For example, the slope adjustment(s) may be applied to update a linear/non-linear/polynomial-model-based prediction mode.
   b. For example, the slope adjustment parameter(s) may be derived based on the average of sample values.
      i. For example, neighboring luma sample values and/or neighboring chroma sample values of the current block may be used.
      ii. For example, neighboring luma sample values and/or neighboring chroma sample values of a reference block may be used.
   c. For example, the slope adjustment factor for CCLM and MMLM models may be calculated based on division-free operations.
c. For example, the division-free operation may be based on a multiplication with a scale factor and a shift operation.
   a. For example, the division of “divisor=sum/num” may be represented as “divisor=(sum*scale)>>shift”.
   b. For example, the scale factor and/or the shift value may be calculated based on denominator.
   c. For example, the shift value may be calculated based on log 2 of denominator.
   d. For example, the denominator may be normalized to range of T1 and T2 (such as T1=1.0 and T2=2.0) by applying the shift operation.
   e. For example, the scale factor may be calculated based on the fractional part (with K-bit precision) of the normalized denominator, wherein K is a pre-defined integer, such as K=14.
d. For example, the division-free operations may be based on a piece-wise polynomial function.
   a. For example, the scale factor may be calculated based on a M-piece polynomial model, wherein M is a pre-defined integer equal to power of 2.
   b. For example, at least one parameter of polynomial model in different pieces may be pre-calculated and stored in a look-up-table.
   c. For example, the coefficient of power of 1 term may be implemented by shift operation and no storage for this value.
e. For example, the division-free operations may be based on an integer look-up table (LUT).

### 4.2 about Offset-Removal-Based Methods and Related Issues (e.g., the Second Problem), the Following Methods are Proposed

a. For example, at least one of the following methods may be designed based on offset removal:
   a. A cross-component method that builds relationship between luma block samples and chroma block samples.
   b. An inter-prediction method that builds relationship between current block/template/area samples and reference block/template/area samples.
   c. An intra-prediction method that builds relationship between current block/template/area samples and reference block/template/area samples.
   d. An intra/inter-prediction method that builds relationship between prediction values and reconstruction values of reference/template/neighboring samples.
   e. An SCC-prediction method that builds relationship between current block/template/area samples and reference block/template/area samples.
   f. template matching (and/or its variants) based method.
   g. template cost (and/or its variants) based method.
   h. template (and/or its variants) based method.
   i. fusion/blending based method (such as blending weights derivation of TIMD/DIMD/CIIP/GPM/SGPM/MHP/BCW/chroma fusion/luma fusion, and etc.).
   j. CCLM and/or its variants.
   k. MMLM and/or its variants.
   l. CCCM and/or its variants.
   m. GLM and/or its variants.
   n. LIC and/or its variants.
   o. intraTMP and/or its variants.
b. For example, a cost/error/SAD/SATD/MSE/SSE/difference calculation between samples in a first block/template/area and samples in a second block/template/area may be applied based on an offset removal method.
   a. For example, an offset may be firstly removed for each pair of samples, then a cost/error/SAD/SATD/MSE/SSE/difference is calculated based on the offset removed differences.
c. For example, a prediction/reconstruction value for a sample in a block/template/area may be subtracted by an offset, then used for model (or cost) calculation.
d. For example, the offset may be calculated based on one of the followings:
   a. sample value of a certain sample (or a pair of samples) at a pre-defined position.
      i. For example, a prediction/reconstruction sample value at a pre-defined position within/neighboring a template.
      ii. For example, a prediction/reconstruction sample value at a pre-defined position within/neighboring a reference block.
      iii. For example, the difference between a first prediction/reconstruction sample value at a pre-defined position within/neighboring a first template and a second prediction/reconstruction sample value at a pre-defined position within/neighboring a second template.
      iv. For example, the difference between a first prediction/reconstruction sample value at a pre-defined position within/neighboring a first reference block and a second prediction/reconstruction sample value at a pre-defined position within/neighboring a second reference block.
      v. For example, the pre-defined position may be top-left, or top-right, or bottom-left, or bottom-right, or center of the template (or reference block).
   b. A value calculated by a function based on more than one sample in a block/template/area (or a pair of blocks/templates).
      i. For example, the function may be based on difference between at least two prediction/reconstruction samples in a first template and prediction/reconstruction samples in a second template.
      ii. For example, the function may be based on difference between at least two prediction/reconstruction samples in a first reference block and prediction/reconstruction samples in a second reference block.
      iii. For example, the function may be based on all samples in the template (or reference block).
      iv. For example, the function may be based on at least two samples at pre-defined positions in the template (or reference block).
      v. For example, the function may be based on average/mid/mean/max/min of eligible values.

### 4.3 about Solving Linear/Non-Linear/Polynomial Regression Model and Related Issues (e.g., the Third Problem), the Following Methods are Proposed

a. For example, at least one of the following methods may be designed on linear/non-linear/polynomial regression model solving:
   a. A cross-component method that builds relationship between luma block samples and chroma block samples.
   b. An inter-prediction method that builds relationship between current block/template/area samples and reference block/template/area samples.
   c. An intra-prediction method that builds relationship between current block/template/area samples and reference block/template/area samples.
   d. An intra/inter-prediction method that builds relationship between prediction values and reconstruction values of reference/template/neighboring samples.
   e. An SCC-prediction method that builds relationship between current block/template/area samples and reference block/template/area samples.
   f. template matching (and/or its variants) based method.
   g. template cost (and/or its variants) based method.
   h. template (and/or its variants) based method.
   i. fusion/blending based method (such as blending weights derivation of TIMD/DIMD/CIIP/GPM/SGPM/MHP/BCW/chroma fusion/luma fusion, and etc.).
   j. CCLM and/or its variants.
   k. MMLM and/or its variants.
   l. CCCM and/or its variants.
   m. GLM and/or its variants.
   n. LIC and/or its variants.
   o. intraTMP and/or its variants.
b. For example, a linear/non-linear/polynomial regression model may be represented as sampVal=a₀Y₀+a₁Y₁+a₂Y₂+a₃Y₃+ . . . +aᵢYᵢ+aᵢYᵢ+aᵢ₊₁B, wherein Y₀ . . . Yᵢ represents values based on reconstruction/prediction samples in a input area (e.g., reference block/template, etc), B represent a bias term, a₀ . . . aᵢ₊₁ represent filter coefficients, and sampVal represents a prediction value in the output area (e.g., current block/template, etc).
c. For example, the coefficients of the linear/non-linear/polynomial regression model may be solved/calculated based on regression based MSE minimization.
   a. For example, it may be based on minimizing MSE/SSE/SAD/SATD/difference between predicted and reconstructed samples in the reference area (or template).
   b. For example, it may be based on minimizing MSE/SSE/SAD/SATD/difference between reconstructed samples in the reference template and reconstructed samples in the current template.
d. For example, the linear/non-linear/polynomial regression model with already solved/calculated filter coefficients may be applied to calculate the prediction sample values in the current block/template/area.
e. For example, the coefficients of the linear/non-linear/polynomial regression model may be solved based on at least one of the following methods:
   a. LDL decomposition and/or its variants.
   b. LU decomposition and/or its variants.
   c. Cholesky decomposition and/or its variants.
   d. Gaussian elimination and/or its variants.
   e. Least square method and/or its variants.

### 4.4 Whether to and/or how to Apply the Disclosed Methods Above May be Signalled at Sequence Level/Group of Pictures Level/Picture Level/Slice Level/Tile Group Level, Such as in Sequence Header/Picture Header/SPS/VPS/DPS/DCI/PPS/APS/Slice Header/Tile Group Header

### 4.5 Whether to and/or how to Apply the Disclosed Methods Above May be Signalled at PB/TB/CB/PU/TU/CU/VPDU/CTU/CTU Row/Slice/Tile/Sub-Picture/Other Kinds of Region Contain More than One Sample or Pixel

### 4.6 Whether to and/or how to Apply the Disclosed Methods Above May be Dependent on Coded Information, Such as Block Size, Colour Format, Single/Dual Tree Partitioning, Colour Component, Slice/Picture Type

More details will be further discussed below. FIG. 14 illustrates a flowchart of a method 1400 for video processing in accordance with embodiments of the present disclosure. The method 1400 is implemented for a conversion between a current video block of the video and a bitstream of the video.

At block 1410, a coding tool for the current video block is determined based on a regression model. The regression model is associated with at least one of a division-free operation or a coefficient determination operation. For example, the coding tool may use the regression model.

At block 1420, the conversion is performed based on the coding tool. For example, the coding tool may be applied to the current video block. In some embodiments, the conversion may include encoding the current video block into the bitstream. Alternatively, or in addition, in some embodiments, the conversion may include decoding the current video block from the bitstream.

The method 1400 enables applying the coding tool based on a regression model to the current video block. For example, the regression model may be determined based on the division-free operation or the coefficient determination operation.

In some embodiments, the regression model comprises at least one of: a linear regression model, a non-linear regression model, or a polynomial regression model. As used herein, the term “regression model” may be refer to “a linear regression model”, “a non-linear regression model” or “a polynomial regression model”.

In some embodiments, the coding tool comprises at least one of: a cross-component coding tool building a relationship between luma block samples and chroma block samples, an inter-prediction coding tool building a relationship between the current video block or a current template or current area samples and a reference block or a reference template or reference area samples, an intra-prediction coding tool building a relationship between the current video block or a current template or current area samples and a reference block or a reference template or reference area samples, an inter or intra prediction coding tool building a relationship between a prediction value and a reconstruction value of a reference or a template or neighbor samples of the current video block, a screen content coding (SCC) prediction building a relationship between the current video block or a current template or current area samples and a reference block or a reference template or reference area samples, a coding tool based on template matching, a coding tool based on a template cost, a fusion or blending based coding tool, a cross-component linear model (CCLM) or a variant of CCLM, a multi-model linear model (MMLM) or a variant of MMLM, a convolutional cross-component model (CCCM) or a variant of CCCM, a gradient linear model (GLM) or a variant of GLM, a local illumination compensation (LIC) or a variant of LIC, or an intra template matching prediction (intraTMP) coding tool or a variant of intraTMP.

In some embodiments, the fusion or blending based coding tool comprises a blending weight determination of at least one of: a template-based intra mode derivation (TIMD), a decoder side intra mode derivation (DIMD), s combined inter and intra prediction (CIIP), a geometric partitioning mode (GPM), a spatial GPM (SGPM), a multi-hypothesis prediction (MHP), a bi-prediction with coding unit (CU)-level weight (BCW), a chroma fusion, or a luma fusion.

In some embodiments, the regression model is updated based on a slope adjustment parameter determined from the division-free operation. For example, a linear/non-linear/polynomial regression model may be updated based on slope adjustment parameter(s), in which the slope adjustment parameter is derived from division-free operations.

In some embodiments, the slope adjustment parameter is applied to update a prediction mode based on the regression model. For example, the slope adjustment(s) may be applied to update a linear/non-linear/polynomial-model-based prediction mode.

In some embodiments, the method 1400 further comprises: determining the slope adjustment parameter based on an average of a plurality of sample values associated with the current video block.

In some embodiments, the plurality of sample values comprises at least one of: at least one neighboring luma sample value of the current video block, or at least one neighboring chroma sample value of the current video block.

In some embodiments, the plurality of sample values comprises at least one of: at least one neighboring luma sample value of a reference block of the current video block, or at least one neighboring chroma sample value of the reference block.

In some embodiments, the slope adjustment parameter is determined based on the division-free operation, and the slope adjustment parameter using for at least one of: a cross-component linear model (CCLM) or a multi-model linear model (MMLM). For example, the slope adjustment factor for CCLM and MMLM models may be calculated based on division-free operations.

In some embodiments, the division-free operation is based on a multiplication with a scale factor and a shift operation.

In some embodiments, a division operation is replaced by the division-free operation comprising a multiplication operation with a scale factor and a shift operation. For example, the division of “divisor=sum/num” may be represented as “divisor=(sum*scale)>>shift”.

In some embodiments, at least one of the scale factor or a shift value of the shift operation is determined based on a denominator of the division operation.

In some embodiments, the shift value is determined based on a log value of the denominator. For example, the shift value may be calculated based on log 2 of denominator.

In some embodiments, the denominator is normalized to a predetermined range by applying the shift operation. In some embodiments, the predetermined range is from 1.0 to 2.0.

In some embodiments, the scale factor is determined based on a fractional part of the normalized denominator, the factional part being of a predefined precision.

In some embodiments, the predefined precision comprises a precision corresponding to a predefined number of bits. For example, the predefined number may be 14.

In some embodiments, the division-free operation is based on a piece-wise polynomial metric.

In some embodiments, the scale factor of the division-free operation is determined based on an M-piece polynomial model, M being a predefined integer equal to a power of 2. For example, the scale factor may be calculated based on a M-piece polynomial model, wherein M is a pre-defined integer equal to power of 2.

In some embodiments, at least one parameter of the polynomial model in a plurality of pieces of the polynomial model is predetermined and stored in a look-up table.

In some embodiments, a coefficient of power of 1 term is implemented by the shift operation and no storage is for a value of the coefficient. For example, the coefficient of power of 1 term may be implemented by shift operation and no storage for this value.

In some embodiments, the division-free operation is based on an integer look-up table (LUT).

In some embodiments, the regression model comprises an operation that: sampVal=a0Y0+a1Y1+a2Y2+a3Y3+ . . . +ai Yi+ai+1B, wherein Y0, Y1, Y2, Y3, . . . Yi denote values based on reconstruction or prediction samples in a input area, B denotes a bias term, a0, a1, a2, a3, . . . ai+1 denote filter coefficients, and sampVal denotes a prediction value in an output area. For example, the input area may be a template or a reference block of the current video block, and the output area may be a template or the current video block. That is, a linear/non-linear/polynomial regression model may be represented as sampVal=a₀Y₀+a₁Y₁+a₂Y₂+a₃Y₃+ . . . +aᵢ Yᵢ+aᵢ₊₁B, wherein Y₀ . . . Yᵢ represents values based on reconstruction/prediction samples in a input area (e.g., reference block/template, etc), B represent a bias term, a₀ . . . aᵢ₊₁ represent filter coefficients, and sampVal represents a prediction value in the output area (e.g., current block/template, etc).

In some embodiments, the coefficient determination operation comprises: determining at least one coefficient of the regression model based on a regression based mean square error (MSE) minimization.

In some embodiments, the regression based MSE minimization is based on at least one of: minimizing a metric value between predicted and reconstructed samples in a reference area or a template of the current video block, or minimizing a metric value between reconstructed samples in a reference template of the current video block and reconstructed samples in a current template of the current video block.

In some embodiments, the metric value comprises at least one of: a mean square error (MSE), a sum of squared error (SSE), a sum of absolute differences (SAD), a sum of absolute transformed differences (SATD), or a difference.

In some embodiments, the regression model with filter coefficients determined based on the coefficient determination operation is applied to determine a prediction sample value in at least one of: the current video block, a template of the current video block, or an area.

In some embodiments, the coefficient determination operation is based on at least one of: an LDL decomposition or a variant of LDL decomposition, an LU decomposition or a variant of LU decomposition, a Cholesky decomposition or a variant of Cholesky decomposition, a Gaussian elimination or a variant of Gaussian elimination, or a least square tool or a variant of least square tool.

According to further embodiments of the present disclosure, a non-transitory computer-readable recording medium is provided. The non-transitory computer-readable recording medium stores a bitstream of a video which is generated by a method performed by an apparatus for video processing. In the method, a coding tool for a current video block of the video is determined based on a regression model.

The bitstream is generated based on the coding tool. The regression model is associated with at least one of: a division-free operation, or a coefficient determination operation.

According to still further embodiments of the present disclosure, a method for storing bitstream of a video is provided. In the method, a coding tool for a current video block of the video is determined based on a regression model. The bitstream is generated based on the coding tool. The bitstream is stored in a non-transitory computer-readable recording medium. The regression model is associated with at least one of: a division-free operation, or a coefficient determination operation.

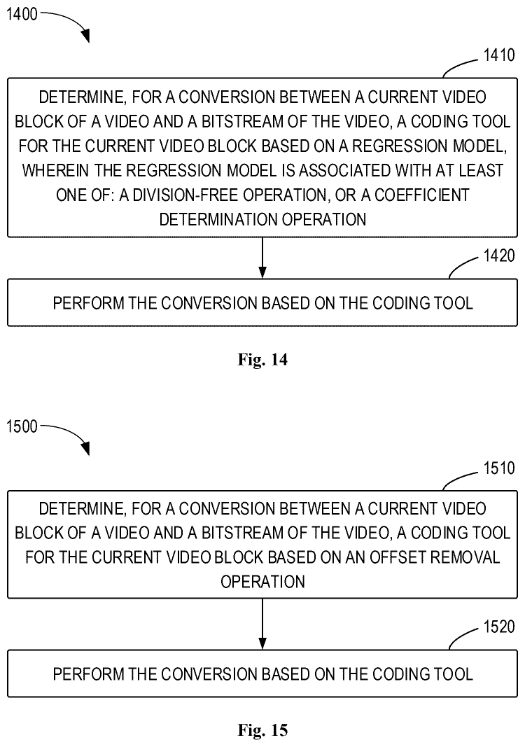

FIG. 15 illustrates a flowchart of a method 1500 for video processing in accordance with embodiments of the present disclosure. The method 1500 is implemented for a conversion between a current video block of a video and a bitstream of the video.

At block 1510, a coding tool of the current video block is determined based on an offset removal operation.

At block 1520, the conversion is performed based on the coding tool. For example, the coding tool may be applied to the current video block. In some embodiments, the conversion may include encoding the current video block into the bitstream. Alternatively, or in addition, in some embodiments, the conversion may include decoding the current video block from the bitstream.

The method 1500 enables applying the coding tool based on an offset removal operation to the current video block. In this way, the coding efficiency and coding effectiveness can be improved.

In some embodiments, the coding tool comprises at least one of: a cross-component coding tool building a relationship between luma block samples and chroma block samples, an inter-prediction coding tool building a relationship between the current video block or a current template or current area samples and a reference block or a reference template or reference area samples, an intra-prediction coding tool building a relationship between the current video block or a current template or current area samples and a reference block or a reference template or reference area samples, an inter or intra prediction coding tool building a relationship between a prediction value and a reconstruction value of a reference or a template or neighbor samples of the current video block, a screen content coding (SCC) prediction building a relationship between the current video block or a current template or current area samples and a reference block or a reference template or reference area samples, a coding tool based on template matching, a coding tool based on a template cost, a fusion or blending based coding tool, a cross-component linear model (CCLM) or a variant of CCLM, a multi-model linear model (MMLM) or a variant of MMLM, a convolutional cross-component model (CCCM) or a variant of CCCM, a gradient linear model (GLM) or a variant of GLM, a local illumination compensation (LIC) or a variant of LIC, or an intra template matching prediction (intraTMP) coding tool or a variant of intraTMP.

In some embodiments, the fusion or blending based coding tool comprises a blending weight determination of at least one of: a template-based intra mode derivation (TIMD), a decoder side intra mode derivation (DIMD), s combined inter and intra prediction (CIIP), a geometric partitioning mode (GPM), a spatial GPM (SGPM), a multi-hypothesis prediction (MHP), a bi-prediction with coding unit (CU)-level weight (BCW), a chroma fusion, or a luma fusion.

In some embodiments, in the coding tool, a metric value between samples in a first region and samples in a second region is determined based on the offset-removal operation.

In some embodiments, the metric value comprises at least one of: a cost, an error, a sum of absolute differences (SAD), a sum of absolute transformed differences (SATD), a mean square error (MSE), a sum of squared error (SSE), or a difference.

In some embodiments, the first region or the second region comprises at least one of: a block, a template, or an area.

In some embodiments, determining the metric value comprises: removing an offset for each pair of samples in the first and second regions; and determining the metric value based on the samples with offset removal.

In some embodiments, the offset removal operation comprises: determining a prediction or reconstruction value for a sample in a region; and updating the prediction or reconstruction value by subtracting an offset from the prediction or reconstruction value.

In some embodiments, the updated prediction or reconstruction value is used for at least one of: a model determination, or a cost determination.

In some embodiments, the region comprises at least one of: a block, a template, or an area.

In some embodiments, an offset for the offset-removal operation is determined based on at least one of: a sample value of a sample at a predefined position, sample values of a pair of samples at a pair of predefined positions, or a metric value based on a plurality of samples in a region.

In some embodiments, the sample value of the sample at the predefined position comprises a prediction sample value or a reconstruction sample value at the predefined position within a template of the current video block or neighboring to the template.

In some embodiments, the sample value of the sample at the predefined position comprises a prediction sample value or a reconstruction sample value at the predefined position within a reference block of the current video block or neighboring to the reference block.

In some embodiments, the offset is determined based on a difference between the sample values of the pair of samples at the pair of predefined positions, the pair of samples comprising a first prediction or reconstruction sample value at a first predefined position within or neighboring to a first template of the current video block and a second prediction or reconstruction sample value at a second predefined position within or neighboring to a second template of the current video block, the first predefined position corresponding to the second predefined position.

In some embodiments, the offset is determined based on a difference between the sample values of the pair of samples at the pair of predefined positions, the pair of samples comprising a first prediction or reconstruction sample value at a first predefined position within or neighboring to a first reference block of the current video block and a second prediction or reconstruction sample value at a second predefined position within or neighboring to a second reference block of the current video block, the first predefined position corresponding to the second predefined position.

In some embodiments, the predefined position or the pair of predefined positions comprises at least one of: a top-left position of a template or a reference block of the current video block, a top-right position of a template or a reference block of the current video block, a bottom-left position of a template or a reference block of the current video block, a bottom-right position of a template or a reference block of the current video block, or a center position of a template or a reference block of the current video block.

In some embodiments, the metric value is determined based on a difference between at least two prediction or reconstruction samples in a first template of the current video block and at least two prediction or reconstruction samples in a second template of the current video block.

In some embodiments, the metric value is determined based on a difference between at least two prediction or reconstruction samples in a first reference block of the current video block and at least two prediction or reconstruction samples in a second reference block of the current video block.

In some embodiments, the metric value is determined based on samples in a template or a reference block of the current video block.

In some embodiments, the metric value is determined based on at least two samples at predefined positions in a template or a reference block of the current video block.

In some embodiments, the metric value is determined based on at least one of: an average value of eligible values, a middle value of eligible values, a mean of eligible values, a maximum of eligible values, or a minimum of eligible values.

According to further embodiments of the present disclosure, a non-transitory computer-readable recording medium is provided. The non-transitory computer-readable recording medium stores a bitstream of a video which is generated by a method performed by an apparatus for video processing. In the method, a coding tool for a current video block of the video is determined based on an offset removal operation. The bitstream is generated based on the coding tool.

According to still further embodiments of the present disclosure, a method for storing bitstream of a video is provided. In the method, a coding tool for a current video block of the video is determined based on an offset removal operation. The bitstream is generated based on the coding tool. The bitstream is stored in a non-transitory computer-readable recording medium.

In some embodiments, information regarding whether to and/or how to apply the method 1400 and/or the method 1500 is included in the bitstream.

In some embodiments, the information is indicated at one of: a sequence level, a group of pictures level, a picture level, a slice level, or a tile group level.

In some embodiments, the information is indicated in a sequence header, a picture header, a sequence parameter set (SPS), a Video Parameter Set (VPS), a decoded parameter set (DPS), Decoding Capability Information (DCI), a Picture Parameter Set (PPS), an Adaptation Parameter Set (APS), a slice header, or a tile group header.

In some embodiments, the information is indicated in a region containing more than one sample or pixel.

In some embodiments, the region comprises one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, or a subpicture.

In some embodiments, the method 1400 and/or the method 1500 further comprises: determining the information based on coded information.

In some embodiments, the coded information comprises at least one of: a block size, a color format, a single or dual tree partitioning, a color component, a slice type, or a picture type.

It is to be understood that the methods 1400 and 1500 may be applied separately or in any combination. By using these methods 1400 and/or 1500 separately or in combination, the coding effectiveness and/or coding efficiency can be improved.

Implementations of the present disclosure can be described in view of the following clauses, the features of which can be combined in any reasonable manner.

Clause 1. A method for video processing, comprising: determining, for a conversion between a current video block of a video and a bitstream of the video, a coding tool for the current video block based on a regression model; and performing the conversion based on the coding tool, wherein the regression model is associated with at least one of: a division-free operation, or a coefficient determination operation.

Clause 2. The method of clause 1, wherein the regression model comprises at least one of: a linear regression model, a non-linear regression model, or a polynomial regression model.

Clause 3. The method of clause 1 or 2, wherein the coding tool comprises at least one of: a cross-component coding tool building a relationship between luma block samples and chroma block samples, an inter-prediction coding tool building a relationship between the current video block or a current template or current area samples and a reference block or a reference template or reference area samples, an intra-prediction coding tool building a relationship between the current video block or a current template or current area samples and a reference block or a reference template or reference area samples, an inter or intra prediction coding tool building a relationship between a prediction value and a reconstruction value of a reference or a template or neighbor samples of the current video block, a screen content coding (SCC) prediction building a relationship between the current video block or a current template or current area samples and a reference block or a reference template or reference area samples, a coding tool based on template matching, a coding tool based on a template cost, a fusion or blending based coding tool, a cross-component linear model (CCLM) or a variant of CCLM, a multi-model linear model (MMLM) or a variant of MMLM, a convolutional cross-component model (CCCM) or a variant of CCCM, a gradient linear model (GLM) or a variant of GLM, a local illumination compensation (LIC) or a variant of LIC, or an intra template matching prediction (intraTMP) coding tool or a variant of intraTMP.

Clause 4. The method of clause 3, wherein the fusion or blending based coding tool comprises a blending weight determination of at least one of: a template-based intra mode derivation (TIMD), a decoder side intra mode derivation (DIMD), s combined inter and intra prediction (CIIP), a geometric partitioning mode (GPM), a spatial GPM (SGPM), a multi-hypothesis prediction (MHP), a bi-prediction with coding unit (CU)-level weight (BCW), a chroma fusion, or a luma fusion.

Clause 5. The method of any of clauses 1-4, wherein the regression model is updated based on a slope adjustment parameter determined from the division-free operation.

Clause 6. The method of clause 5, wherein the slope adjustment parameter is applied to update a prediction mode based on the regression model.

Clause 7. The method of clause 5 or 6, further comprising: determining the slope adjustment parameter based on an average of a plurality of sample values associated with the current video block.

Clause 8. The method of clause 7, wherein the plurality of sample values comprises at least one of: at least one neighboring luma sample value of the current video block, or at least one neighboring chroma sample value of the current video block.

Clause 9. The method of clause 7, wherein the plurality of sample values comprises at least one of: at least one neighboring luma sample value of a reference block of the current video block, or at least one neighboring chroma sample value of the reference block.

Clause 10. The method of clause 5 or 6, wherein the slope adjustment parameter is determined based on the division-free operation, and the slope adjustment parameter using for at least one of: a cross-component linear model (CCLM) or a multi-model linear model (MMLM).

Clause 11. The method of any of clauses 5-10, wherein the division-free operation is based on a multiplication with a scale factor and a shift operation.

Clause 12. The method of any of clauses 5-10, wherein a division operation is replaced by the division-free operation comprising a multiplication operation with a scale factor and a shift operation.

Clause 13. The method of clause 12, wherein at least one of the scale factor or a shift value of the shift operation is determined based on a denominator of the division operation.

Clause 14. The method of clause 13, wherein the shift value is determined based on a log value of the denominator.

Clause 15. The method of clause 13 or 14, wherein the denominator is normalized to a predetermined range by applying the shift operation.

Clause 16. The method of clause 15, wherein the predetermined range is from 1.0 to 2.0.

Clause 17. The method of clause 15 or 16, wherein the scale factor is determined based on a fractional part of the normalized denominator, the factional part being of a predefined precision.

Clause 18. The method of clause 17, wherein the predefined precision comprises a precision corresponding to a predefined number of bits.

Clause 19. The method of clause 18, wherein the predefined number is 14.

Clause 20. The method of any of clauses 11-19, wherein the division-free operation is based on a piece-wise polynomial metric.

Clause 21. The method of clause 20, wherein the scale factor of the division-free operation is determined based on an M-piece polynomial model, M being a predefined integer equal to a power of 2.

Clause 22. The method of clause 21, wherein at least one parameter of the polynomial model in a plurality of pieces of the polynomial model is predetermined and stored in a look-up table.

Clause 23. The method of any of clauses 20-22, wherein a coefficient of power of 1 term is implemented by the shift operation and no storage is for a value of the coefficient.

Clause 24. The method of any of clauses 11-23, wherein the division-free operation is based on an integer look-up table (LUT).

Clause 25. The method of any of clauses 1-24. wherein the regression model comprises an operation that: sampVal=a0Y0+a1Y1+a2Y2+a3Y3+ . . . +ai Yi+ai+1B, wherein Y0, Y1, Y2, Y3, . . . Yi denote values based on reconstruction or prediction samples in a input area, B denotes a bias term, a0, a1, a2, a3, . . . ai+1 denote filter coefficients, and sampVal denotes a prediction value in an output area.

Clause 26. The method of clause 25, wherein the input area comprises a template or a reference block of the current video block, and the output area comprises a template or the current video block.

Clause 27. The method of any of clauses 1-26, wherein the coefficient determination operation comprises: determining at least one coefficient of the regression model based on a regression based mean square error (MSE) minimization.

Clause 28. The method of clause 27, wherein the regression based MSE minimization is based on at least one of: minimizing a metric value between predicted and reconstructed samples in a reference area or a template of the current video block, or minimizing a metric value between reconstructed samples in a reference template of the current video block and reconstructed samples in a current template of the current video block.

Clause 29. The method of clause 28, wherein the metric value comprises at least one of: a mean square error (MSE), a sum of squared error (SSE), a sum of absolute differences (SAD), a sum of absolute transformed differences (SATD), or a difference.

Clause 30. The method of any of clauses 1-29, wherein the regression model with filter coefficients determined based on the coefficient determination operation is applied to determine a prediction sample value in at least one of: the current video block, a template of the current video block, or an area.

Clause 31. The method of any of clauses 1-30, wherein the coefficient determination operation is based on at least one of: an LDL decomposition or a variant of LDL decomposition, an LU decomposition or a variant of LU decomposition, a Cholesky decomposition or a variant of Cholesky decomposition, a Gaussian elimination or a variant of Gaussian elimination, or a least square tool or a variant of least square tool.

Clause 32. A method for video processing, comprising: determining, for a conversion between a current video block of a video and a bitstream of the video, a coding tool of the current video block based on an offset removal operation; and performing the conversion based on the coding tool.

Clause 33. The method of clause 32, wherein the coding tool comprises at least one of: a cross-component coding tool building a relationship between luma block samples and chroma block samples, an inter-prediction coding tool building a relationship between the current video block or a current template or current area samples and a reference block or a reference template or reference area samples, an intra-prediction coding tool building a relationship between the current video block or a current template or current area samples and a reference block or a reference template or reference area samples, an inter or intra prediction coding tool building a relationship between a prediction value and a reconstruction value of a reference or a template or neighbor samples of the current video block, a screen content coding (SCC) prediction building a relationship between the current video block or a current template or current area samples and a reference block or a reference template or reference area samples, a coding tool based on template matching, a coding tool based on a template cost, a fusion or blending based coding tool, a cross-component linear model (CCLM) or a variant of CCLM, a multi-model linear model (MMLM) or a variant of MMLM, a convolutional cross-component model (CCCM) or a variant of CCCM, a gradient linear model (GLM) or a variant of GLM, a local illumination compensation (LIC) or a variant of LIC, or an intra template matching prediction (intraTMP) coding tool or a variant of intraTMP.

Clause 34. The method of clause 33, wherein the fusion or blending based coding tool comprises a blending weight determination of at least one of: a template-based intra mode derivation (TIMD), a decoder side intra mode derivation (DIMD), s combined inter and intra prediction (CIIP), a geometric partitioning mode (GPM), a spatial GPM (SGPM), a multi-hypothesis prediction (MHP), a bi-prediction with coding unit (CU)-level weight (BCW), a chroma fusion, or a luma fusion.

Clause 35. The method of any of clauses 32-34, wherein in the coding tool, a metric value between samples in a first region and samples in a second region is determined based on the offset-removal operation.

Clause 36. The method of clause 35, wherein the metric value comprises at least one of: a cost, an error, a sum of absolute differences (SAD), a sum of absolute transformed differences (SATD), a mean square error (MSE), a sum of squared error (SSE), or a difference.

Clause 37. The method of clause 35 or 36, wherein the first region or the second region comprises at least one of: a block, a template, or an area.

Clause 38. The method of any of clauses 35-37, wherein determining the metric value comprises: removing an offset for each pair of samples in the first and second regions; and determining the metric value based on the samples with offset removal.

Clause 39. The method of any of clauses 32-38, wherein the offset removal operation comprises: determining a prediction or reconstruction value for a sample in a region; and updating the prediction or reconstruction value by subtracting an offset from the prediction or reconstruction value.

Clause 40. The method of clause 39, wherein the updated prediction or reconstruction value is used for at least one of: a model determination, or a cost determination.

Clause 41. The method of clause 39 or 40, wherein the region comprises at least one of: a block, a template, or an area.

Clause 42. The method of any of clauses 32-41, wherein an offset for the offset-removal operation is determined based on at least one of: a sample value of a sample at a predefined position, sample values of a pair of samples at a pair of predefined positions, or a metric value based on a plurality of samples in a region.

Clause 43. The method of clause 42, wherein the sample value of the sample at the predefined position comprises a prediction sample value or a reconstruction sample value at the predefined position within a template of the current video block or neighboring to the template.

Clause 44. The method of clause 42, wherein the sample value of the sample at the predefined position comprises a prediction sample value or a reconstruction sample value at the predefined position within a reference block of the current video block or neighboring to the reference block.

Clause 45. The method of clause 42, wherein the offset is determined based on a difference between the sample values of the pair of samples at the pair of predefined positions, the pair of samples comprising a first prediction or reconstruction sample value at a first predefined position within or neighboring to a first template of the current video block and a second prediction or reconstruction sample value at a second predefined position within or neighboring to a second template of the current video block, the first predefined position corresponding to the second predefined position.

Clause 46. The method of clause 42, wherein the offset is determined based on a difference between the sample values of the pair of samples at the pair of predefined positions, the pair of samples comprising a first prediction or reconstruction sample value at a first predefined position within or neighboring to a first reference block of the current video block and a second prediction or reconstruction sample value at a second predefined position within or neighboring to a second reference block of the current video block, the first predefined position corresponding to the second predefined position.

Clause 47. The method of any of clauses 42-46, wherein the predefined position or the pair of predefined positions comprises at least one of: a top-left position of a template or a reference block of the current video block, a top-right position of a template or a reference block of the current video block, a bottom-left position of a template or a reference block of the current video block, a bottom-right position of a template or a reference block of the current video block, or a center position of a template or a reference block of the current video block.

Clause 48. The method of clause 42, wherein the metric value is determined based on a difference between at least two prediction or reconstruction samples in a first template of the current video block and at least two prediction or reconstruction samples in a second template of the current video block.

Clause 49. The method of clause 42, wherein the metric value is determined based on a difference between at least two prediction or reconstruction samples in a first reference block of the current video block and at least two prediction or reconstruction samples in a second reference block of the current video block.

Clause 50. The method of clause 42, wherein the metric value is determined based on samples in a template or a reference block of the current video block.

Clause 51. The method of clause 42, wherein the metric value is determined based on at least two samples at predefined positions in a template or a reference block of the current video block.

Clause 52. The method of clause 42, wherein the metric value is determined based on at least one of: an average value of eligible values, a middle value of eligible values, a mean of eligible values, a maximum of eligible values, or a minimum of eligible values.

Clause 53. The method of any of clauses 1-52, wherein information regarding whether to and/or how to apply the method is included in the bitstream.

Clause 54. The method of clause 53, wherein the information is indicated at one of: a sequence level, a group of pictures level, a picture level, a slice level, or a tile group level.

Clause 55. The method of clause 53 or 54, wherein the information is indicated in a sequence header, a picture header, a sequence parameter set (SPS), a Video Parameter Set (VPS), a decoded parameter set (DPS), Decoding Capability Information (DCI), a Picture Parameter Set (PPS), an Adaptation Parameter Set (APS), a slice header, or a tile group header.

Clause 56. The method of any of clauses 53-55, wherein the information is indicated in a region containing more than one sample or pixel.

Clause 57. The method of clause 56, wherein the region comprises one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, or a subpicture.

Clause 58. The method of any of clauses 53-37, further comprising: determining the information based on coded information.

Clause 59. The method of clause 58, wherein the coded information comprises at least one of: a block size, a color format, a single or dual tree partitioning, a color component, a slice type, or a picture type.

Clause 60. The method of any of clauses 1-59, wherein the conversion includes encoding the current video block into the bitstream.

Clause 61. The method of any of clauses 1-59, wherein the conversion includes decoding the current video block from the bitstream.

Clause 62. An apparatus for video processing comprising a processor and a non-transitory memory with instructions thereon, wherein the instructions upon execution by the processor, cause the processor to perform a method in accordance with any of clauses 1-61.

Clause 63. A non-transitory computer-readable storage medium storing instructions that cause a processor to perform a method in accordance with any of clauses 1-61.

Clause 64. A non-transitory computer-readable recording medium storing a bitstream of a video which is generated by a method performed by an apparatus for video processing, wherein the method comprises: determining a coding tool for a current video block of the video based on a regression model; and generating the bitstream based on the coding tool, wherein the regression model is associated with at least one of: a division-free operation, or a coefficient determination operation.

Clause 65. A method for storing a bitstream of a video, comprising: determining a coding tool for a current video block of the video based on a regression model; generating the bitstream based on the coding tool; and storing the bitstream in a non-transitory computer-readable recording medium, wherein the regression model is associated with at least one of: a division-free operation, or a coefficient determination operation.

Clause 66. A non-transitory computer-readable recording medium storing a bitstream of a video which is generated by a method performed by an apparatus for video processing, wherein the method comprises: determining a coding tool for a current video block of the video based on an offset removal operation; and generating the bitstream based on the coding tool.

Clause 67. A method for storing a bitstream of a video, comprising: determining a coding tool for a current video block of the video based on an offset removal operation; generating the bitstream based on the coding tool; and storing the bitstream in a non-transitory computer-readable recording medium.

### Example Device

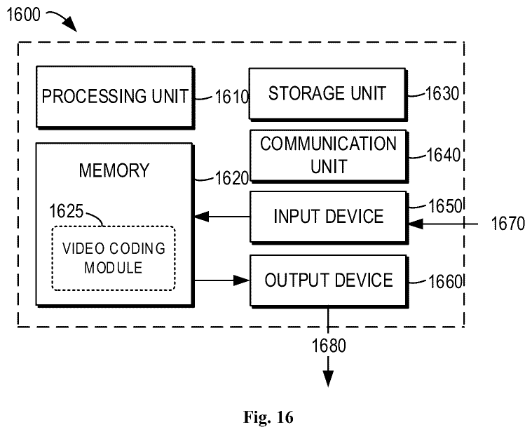

FIG. 16 illustrates a block diagram of a computing device 1600 in which various embodiments of the present disclosure can be implemented. The computing device 1600 may be implemented as or included in the source device 110 (or the video encoder 114 or 200) or the destination device 120 (or the video decoder 124 or 300).

It would be appreciated that the computing device 1600 shown in FIG. 16 is merely for purpose of illustration, without suggesting any limitation to the functions and scopes of the embodiments of the present disclosure in any manner.

As shown in FIG. 16, the computing device 1600 includes a general-purpose computing device 1600. The computing device 1600 may at least comprise one or more processors or processing units 1610, a memory 1620, a storage unit 1630, one or more communication units 1640, one or more input devices 1650, and one or more output devices 1660.

In some embodiments, the computing device 1600 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1600 can support any type of interface to a user (such as “wearable” circuitry and the like).

The processing unit 1610 may be a physical or virtual processor and can implement various processes based on programs stored in the memory 1620. In a multi-processor system, multiple processing units execute computer executable instructions in parallel so as to improve the parallel processing capability of the computing device 1600. The processing unit 1610 may also be referred to as a central processing unit (CPU), a microprocessor, a controller or a microcontroller.

The computing device 1600 typically includes various computer storage medium. Such medium can be any medium accessible by the computing device 1600, including, but not limited to, volatile and non-volatile medium, or detachable and non-detachable medium. The memory 1620 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1630 may be any detachable or non-detachable medium and may include a machine-readable medium such as a memory, flash memory drive, magnetic disk or another other media, which can be used for storing information and/or data and can be accessed in the computing device 1600.

The computing device 1600 may further include additional detachable/non-detachable, volatile/non-volatile memory medium. Although not shown in FIG. 16, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1640 communicates with a further computing device via the communication medium. In addition, the functions of the components in the computing device 1600 can be implemented by a single computing cluster or multiple computing machines that can communicate via communication connections. Therefore, the computing device 1600 can operate in a networked environment using a logical connection with one or more other servers, networked personal computers (PCs) or further general network nodes.

The input device 1650 may be one or more of a variety of input devices, such as a mouse, keyboard, tracking ball, voice-input device, and the like. The output device 1660 may be one or more of a variety of output devices, such as a display, loudspeaker, printer, and the like. By means of the communication unit 1640, the computing device 1600 can further communicate with one or more external devices (not shown) such as the storage devices and display device, with one or more devices enabling the user to interact with the computing device 1600, or any devices (such as a network card, a modem and the like) enabling the computing device 1600 to communicate with one or more other computing devices, if required. Such communication can be performed via input/output (I/O) interfaces (not shown).

In some embodiments, instead of being integrated in a single device, some or all components of the computing device 1600 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1600 may be used to implement video encoding/decoding in embodiments of the present disclosure. The memory 1620 may include one or more video coding modules 1625 having one or more program instructions. These modules are accessible and executable by the processing unit 1610 to perform the functionalities of the various embodiments described herein.

In the example embodiments of performing video encoding, the input device 1650 may receive video data as an input 1670 to be encoded. The video data may be processed, for example, by the video coding module 1625, to generate an encoded bitstream. The encoded bitstream may be provided via the output device 1660 as an output 1680.

In the example embodiments of performing video decoding, the input device 1650 may receive an encoded bitstream as the input 1670. The encoded bitstream may be processed, for example, by the video coding module 1625, to generate decoded video data. The decoded video data may be provided via the output device 1660 as the output 1680.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

What is claimed is:

1. A method for video processing, comprising:
determining, for a conversion between a current video block of a video and a bitstream of the video, a coding tool for the current video block based on a regression model; and
performing the conversion based on the coding tool,
wherein the regression model is associated with at least one of: a division-free operation, or a coefficient determination operation.

2. The method of claim 1, wherein the regression model comprises at least one of:
a linear regression model,
a non-linear regression model, or
a polynomial regression model.

3. The method of claim 1, wherein the coding tool comprises at least one of:
a cross-component coding tool building a relationship between luma block samples and chroma block samples,
an inter-prediction coding tool building a relationship between the current video block or a current template or current area samples and a reference block or a reference template or reference area samples,
an intra-prediction coding tool building a relationship between the current video block or a current template or current area samples and a reference block or a reference template or reference area samples,
an inter or intra prediction coding tool building a relationship between a prediction value and a reconstruction value of a reference or a template or neighbor samples of the current video block,
a screen content coding (SCC) prediction building a relationship between the current video block or a current template or current area samples and a reference block or a reference template or reference area samples,
a coding tool based on template matching,
a coding tool based on a template cost,
a fusion or blending based coding tool,
a cross-component linear model (CCLM) or a variant of CCLM,
a multi-model linear model (MMLM) or a variant of MMLM,
a convolutional cross-component model (CCCM) or a variant of CCCM,
a gradient linear model (GLM) or a variant of GLM,
a local illumination compensation (LIC) or a variant of LIC, or
an intra template matching prediction (intraTMP) coding tool or a variant of intraTMP.

4. The method of claim 3, wherein the fusion or blending based coding tool comprises a blending weight determination of at least one of:
a template-based intra mode derivation (TIMD),
a decoder side intra mode derivation (DIMD),
s combined inter and intra prediction (CIIP),
a geometric partitioning mode (GPM),
a spatial GPM (SGPM),
a multi-hypothesis prediction (MHP),
a bi-prediction with coding unit (CU)-level weight (BCW),
a chroma fusion, or
a luma fusion.

5. The method of claim 1, wherein the regression model is updated based on a slope adjustment parameter determined from the division-free operation,
wherein the slope adjustment parameter is applied to update a prediction mode based on the regression model.

6. The method of claim 5, further comprising:
determining the slope adjustment parameter based on an average of a plurality of sample values associated with the current video block,
wherein the plurality of sample values comprises at least one of: at least one neighboring luma sample value of the current video block, or at least one neighboring chroma sample value of the current video block, or
wherein the plurality of sample values comprises at least one of: at least one neighboring luma sample value of a reference block of the current video block, or at least one neighboring chroma sample value of the reference block.

7. The method of claim 5, wherein the slope adjustment parameter is determined based on the division-free operation, and the slope adjustment parameter using for at least one of: a cross-component linear model (CCLM) or a multi-model linear model (MMLM).

8. The method of claim 5, wherein the division-free operation is based on a multiplication with a scale factor and a shift operation.

9. The method of claim 5, wherein a division operation is replaced by the division-free operation comprising a multiplication operation with a scale factor and a shift operation.

10. The method of claim 9, wherein at least one of the scale factor or a shift value of the shift operation is determined based on a denominator of the division operation, and/or
wherein the shift value is determined based on a log value of the denominator.

11. The method of claim 10, wherein the denominator is normalized to a predetermined range by applying the shift operation, wherein the predetermined range is from 1.0 to 2.0, and/or
wherein the scale factor is determined based on a fractional part of the normalized denominator, the factional part being of a predefined precision, wherein the predefined precision comprises a precision corresponding to a predefined number of bits, wherein the predefined number is 14.

12. The method of claim 8, wherein the division-free operation is based on a piece-wise polynomial metric,
wherein the scale factor of the division-free operation is determined based on an M-piece polynomial model, M being a predefined integer equal to a power of 2,
wherein at least one parameter of the polynomial model in a plurality of pieces of the polynomial model is predetermined and stored in a look-up table,
wherein a coefficient of power of 1 term is implemented by the shift operation and no storage is for a value of the coefficient.

13. The method of claim 8, wherein the division-free operation is based on an integer look-up table (LUT).

14. The method of claim 1, wherein the regression model comprises an operation: sampVa1=a₀Y₀+a₁Y₁+a₂Y₂+a₃Y₃+ . . . +aᵢYᵢ+aᵢ₊₁B,
wherein Y₀, Y₁, Y₂, Y₃, . . . Yᵢ denote values based on reconstruction or prediction samples in a input area, B denotes a bias term, a₀, a₁, a₂, a₃, . . . aᵢ₊₁ denote filter coefficients, and sampVa1 denotes a prediction value in an output area,
wherein the input area comprises a template or a reference block of the current video block, and the output area comprises a template or the current video block.

15. The method of claim 1, wherein the coefficient determination operation comprises:
determining at least one coefficient of the regression model based on a regression based mean square error (MSE) minimization,
wherein the regression based MSE minimization is based on at least one of: minimizing a metric value between predicted and reconstructed samples in a reference area or a template of the current video block, or minimizing a metric value between reconstructed samples in a reference template of the current video block and reconstructed samples in a current template of the current video block,
wherein the metric value comprises at least one of: a mean square error (MSE), a sum of squared error (SSE), a sum of absolute differences (SAD), a sum of absolute transformed differences (SATD), or a difference.

16. The method of claim 1, wherein the regression model with filter coefficients determined based on the coefficient determination operation is applied to determine a prediction sample value in at least one of: the current video block, a template of the current video block, or an area, and/or
wherein the coefficient determination operation is based on at least one of: an LDL decomposition or a variant of LDL decomposition, an LU decomposition or a variant of LU decomposition, a Cholesky decomposition or a variant of Cholesky decomposition, a Gaussian elimination or a variant of Gaussian elimination, or a least square tool or a variant of least square tool.

17. The method of claim 1, wherein the conversion comprises encoding the current video block into the bitstream, or
wherein the conversion comprises decoding the current video block from the bitstream.

18. An apparatus for processing video data comprising a processor and a non-transitory memory with instructions thereon, wherein the instructions upon execution by the processor, cause the processor to:
determine, for a conversion between a current video block of a video and a bitstream of the video, a coding tool for the current video block based on a regression model; and
perform the conversion based on the coding tool,
wherein the regression model is associated with at least one of: a division-free operation, or a coefficient determination operation.

19. A non-transitory computer-readable storage medium storing instructions that cause a processor to perform acts comprising:
determining, for a conversion between a current video block of a video and a bitstream of the video, a coding tool for the current video block based on a regression model; and
performing the conversion based on the coding tool,
wherein the regression model is associated with at least one of: a division-free operation, or a coefficient determination operation.

20. A non-transitory computer-readable recording medium storing a bitstream of a video which is generated by a method performed by a video processing apparatus, wherein the method comprises:
determining a coding tool for a current video block of the video based on a regression model; and
generating the bitstream based on the coding tool,
wherein the regression model is associated with at least one of: a division-free operation, or a coefficient determination operation.
